(19) United States
(12) Patent Application Publication
(10) Pub. No.: US 2025/0094067 A1
(43) Pub. Date: Mar. 20, 2025

(54) STORAGE DEVICE AND OPERATING METHOD THEREOF

(71) Applicant: Samsung Electronics Co., Ltd., Suwon-si (KR)

(72) Inventors: Jaesub KIM, Suwon-si (KR); Jaeyoung KWON, Suwon-si (KR)

(73) Assignee: Samsung Electronics Co., Ltd., Suwon-si (KR)

(21) Appl. No.: 18/799,248

(22) Filed: Aug. 9, 2024

(30) Foreign Application Priority Data
Sep. 14, 2023 (KR) 10-2023-0122669

(51) Int. Cl. G06F 3/06

(52) U.S. Cl. CPC G06F 3/0631; G06F 3/0604; G06F 3/0679

(57) ABSTRACT

A storage device includes at least one non-volatile memory device, and processing circuitry configured to control the non-volatile memory device and communicate with at least one external host device through at least one interface channel, wherein the processing circuitry is further configured to, monitor performances of a plurality of virtual functions, generate status information of the plurality of virtual functions based on the monitored performances of the plurality of virtual functions, and allocate one or more resources to the plurality of virtual functions in real time based on the status information associated with the respective virtual function of the plurality of virtual functions.

### CROSS-REFERENCE TO RELATED APPLICATION

This U.S. non-provisional application is based on and claims the benefit of priority under 35 U.S.C. § 119 to Korean Patent Application No. 10-2023-0122669, filed on Sep. 14, 2023, in the Korean Intellectual Property Office, the disclosure of which is incorporated by reference herein in its entirety.

### BACKGROUND

Various example embodiments of the inventive concepts relate to a semiconductor memory, and more particularly, to a storage device, a system including the storage device, and/or an operating method for the storage device.

Semiconductor memory devices are categorized into volatile memory devices where stored data is deleted and/or lost when the supply of power is cut off from the memory device, like static random access memory (RAM) (SRAM), dynamic RAM (DRAM), flash memory, etc., and non-volatile memory devices which maintain stored data even when the supply of power is cut off, like phase RAM (PRAM), magnetic RAM (MRAM), resistive RAM (RRAM), ferroelectric RAM (FRAM), etc.

Large-capacity storage mediums based on flash memory communicate with an external device by using a high speed interface. Recently, multi-host storage systems have been developed where a single storage medium supports a plurality of tenants or a plurality of hosts, such as a plurality of virtual machines. Particularly, multi-function technology where a single storage medium operating as a plurality of devices is being developed. Multi-function technology may include technology which provides a plurality of physical functions and single root input output virtualization (SR-IOV) technology which implements a plurality of virtual functions with one physical function to provide a plurality of physical functions and a plurality of virtual functions. In providing a same number of functions, RO-IOV technology may decrease the cost compared to a plurality of physical functions.

Generally, in a case where a plurality of hosts accesses a single storage medium, because the physical resources of the single storage medium is limited, a problem where the performance of each of the plurality of hosts is reduced occurs.

### SUMMARY

Various example embodiments of the inventive concepts provide a storage device, a system including the storage device, and/or an operating method for the storage device, etc., which allocate resources to a plurality of virtual functions in real time to enhance and/or improve the total resource efficiency of a storage system.

A storage device includes at least one non-volatile memory device, and processing circuitry configured to control the non-volatile memory device and communicate with at least one external host device through at least one interface channel, wherein the processing circuitry is further configured to, monitor performances of a plurality of virtual functions, generate status information of the plurality of virtual functions based on the monitored performances of the plurality of virtual functions, and allocate one or more resources to the plurality of virtual functions in real time based on the status information associated with the respective virtual function of the plurality of virtual functions.

An operating method of a storage device, includes monitoring, using processing circuitry, current performance of a plurality of virtual functions executing on the storage device, and allocating, using the processing circuitry, one or more resources to one or more of the plurality of virtual functions dynamically based on the monitored current performance of the plurality of virtual functions.

An operating method of a storage device, includes detecting, using processing circuitry, input/output patterns of a plurality of virtual functions, and allocating, using the processing circuitry, one or more resources to the plurality of virtual functions dynamically based on the detected input/output patterns of the plurality of virtual functions.

An operating method of a storage device, includes monitoring, using processing circuitry, an internal status of the storage device, and allocating, using the processing circuitry, one or more resources to the plurality of virtual functions dynamically based on the monitored internal status.

### BRIEF DESCRIPTION OF THE DRAWINGS

Various example embodiments will be more clearly understood from the following detailed description taken in conjunction with the accompanying drawings in which:

FIG. 1 is a block diagram illustrating a storage system according to at least one example embodiment;

FIG. 2 is a block diagram illustrating a storage system according to at least one example embodiment;

FIG. 3 is a block diagram illustrating a storage device according to at least one example embodiment;

FIGS. 4A and 4B are flowcharts illustrating an example of an operating method of a storage device, according to at least one example embodiment;

FIG. 5 is a flowchart illustrating an example of an operating method of a storage device, according to at least one example embodiment;

FIG. 6 is a flowchart illustrating in more detail operation S130 of FIG. 5;

FIGS. 7A to 7D are diagrams for describing an operating method of a storage device, according to at least one example embodiment;

FIG. 8 is a flowchart illustrating an example of an operating method of a storage device, according to at least one example embodiment;

FIG. 9A is a flowchart illustrating in more detail operation S210 of FIG. 8;

FIG. 9B is a flowchart illustrating in more detail operation S230 of FIG. 8;

FIG. 10 is a flowchart illustrating an example of an operating method of a storage device, according to at least one example embodiment;

FIG. 11 is a flowchart illustrating in more detail operation S330 of FIG. 10;

FIGS. 12A and 12B are diagrams for describing an operating method of a storage device, according to at least one example embodiment; FIGS. 12A and 12B are described with reference to FIG. 7B;

FIG. 13 is a block diagram illustrating a host-storage system according to at least one example embodiment; and

FIG. 14 is a diagram illustrating a data center to which a storage system according to at least one example embodiment is applied.

### DETAILED DESCRIPTION

Hereinafter, various example embodiments will be described in detail with reference to the accompanying drawings.

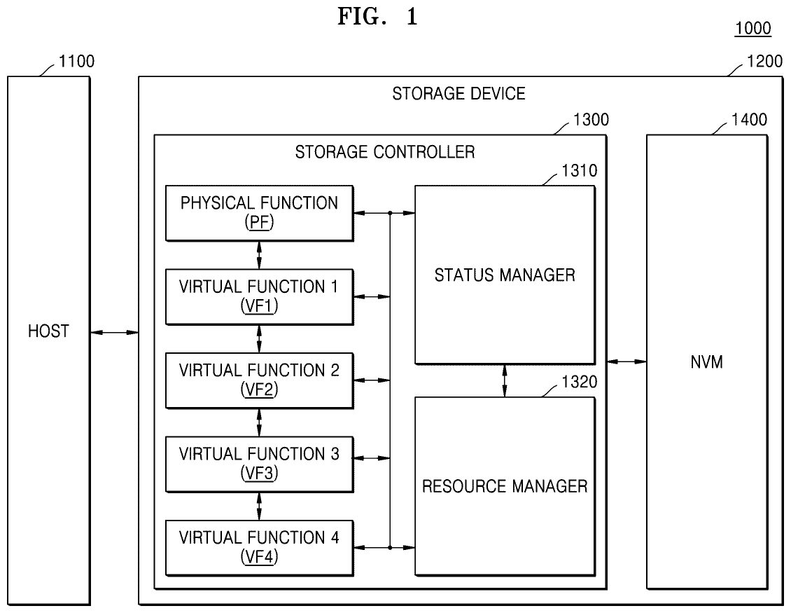

FIG. 1 is a block diagram illustrating a storage system 1000 according to at least one example embodiment.

Referring to FIG. 1, the storage system 1000 may include a host device 1100 and a storage device 1200, etc., but is not limited thereto and for example may include a greater or lesser number of constituent elements. In at least one example embodiment, the storage system 1000 may be a computing system such as a computer, a laptop computer, a server, a workstation, a portable communication terminal, a personal digital assistant (PDA), a portable media player (PMP), a smartphone, a tablet, a virtual reality and/or augmented reality device, a gaming console, and/or a wearable device, etc., but the example embodiments are not limited thereto.

The host device 1100 may be configured to control the overall operation of the storage system 1000. For example, the host device 1100 may be configured to access the storage device 1200. The host device 1100 may store data in the storage device 1200 and/or may read the data stored in the storage device 1200, etc. For example, the host device 1100 may transmit a write command and write data to the storage device 1200 so as to store data in the storage device 1200, etc. Additionally, the host device 1100 may transmit a read command to the storage device 1200 so as to read the data stored in the storage device 1200 and may receive the data from the storage device 1200, etc.

In at least one example embodiment, the host device 1100 and the storage device 1200 may communicate with each other based on a predetermined interface. The predetermined interface may support at least one of various interfaces such as universal serial bus (USB), small computer system interface (SCSI), peripheral component interconnection (PCI) express (PIC-e), advanced technology attachment (ATA), parallel-ATA (PATA), serial-ATA (SATA), serial attached SCSI (SAS), universal flash storage (UFS), non-volatile memory express (NVMe), and/or compute eXpress link (CXL), etc., but the scope of the example embodiments of the inventive concepts are not limited thereto.

The storage device 1200 may operate based on control by the host device 1100. The storage device 1200 may be used as a large-capacity storage medium of the storage system 1000. In at least one example embodiment, the storage device 1200 may be a solid state drive (SSD) equipped in the host device 1100, but is not limited thereto. For example, the storage device 1200 may include at least one storage controller 1300 and a non-volatile memory device 1400, etc. The storage controller 1300 may store the write data, received from the host device 1100, in the non-volatile memory device 1400 in response to the write command received from the host device 1100. The storage controller 1300 may transfer data, read from the non-volatile memory device 1400, to the host device 1100 in response to the read command received from the host device 1100.

The non-volatile memory device 1400 may store data and/or may transfer the stored data to the storage controller 1300 based on control by the storage controller 1300. In at least one example embodiment, the non-volatile memory device 1400 may be a NAND flash memory device, but the scope of the example embodiments of the inventive concepts are not limited thereto.

In at least one example embodiment, the host device 1100 and the storage device 1200 may transfer and receive therebetween through at least one interface channel. For example, the host device 1100 may transmit data to the storage device 1200 and/or may receive data from the storage device 1200 through the interface channel. In at least one example embodiment, the transmission/reception speed of data (and/or the size of data transmitted/received per unit time) through the interface channel may be used as a performance indicator of the storage device 1200.

Hereinafter, for convenience of description, the term “performance of the storage device 1200” may be used. Unless differently defined, the performance of the storage device 1200 may denote a data transmission speed and/or the amount of data per unit time transmitted between the storage device 1200 and the host device 1100.

The storage controller 1300 may include a physical function PF, a virtual function VF, a resource manager 1320, and/or a status manager 1310, etc., but the example embodiments are not limited thereto. In at least one example embodiment, the storage controller 1300 may include the physical function PF and a plurality of virtual functions, e.g., first to fourth virtual functions VF1 to VF4. However, the scope of the example embodiments of the inventive concepts are not limited thereto, and the number of physical functions PF and the number of virtual functions VF may decrease or increase based on an implementation scheme. According to some example embodiments, the storage controller 1300, physical function PF, virtual function VF, resource manager 1320, and/or status manager 1310, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

For example, the number of virtual functions capable of being provided by the storage device 1200 may be 4 or more, or may be less than 4. The number of virtual functions capable of being provided by the storage device 1200 may be 128, etc. The first to fourth virtual functions VF1 to VF4 may be assumed to be virtual functions (and/or on-line virtual functions and active virtual functions) which are being performed.

For example, the physical function PF and the virtual function VF may be a hardware and/or software element configured to provide a predetermined function based on an PCI-e interface protocol. Additionally, or alternatively, one or more of the physical function PF and the virtual function VF may be a PCI-e function which supports single root input output virtualization (SR-IOV). Additionally, or alternatively, one or more of the physical function PF and the virtual function VF may be a sub storage controller. The sub storage controller may be implemented in hardware or as a combination of software and hardware.

The status manager 1310 may perform at least one monitoring operation. The status manager 1310 may be implemented in hardware or as a combination of hardware and software. For example, the monitoring operation may denote an operation of monitoring indicators (and/or parameters, etc.) used to allocate resources. The status manager 1310 may monitor the performance of the plurality of virtual functions, e.g., VF1 to VF4. The status manager 1310 may detect at least one input/output (I/O) pattern of the plurality of virtual functions VF1 to VF4. The status manager 1310 may monitor an internal status of the storage device 1200. For example, the internal status may represent whether a maintenance and management operation of the non-volatile memory device 1400 is being performed, but is not limited thereto.

In at least one example embodiment, the status manager 1310 may periodically perform at least one monitoring operation. The status manager 1310 may include a timer (not shown). The timer may be configured to count a predetermined time period. For example, the timer may be configured to use a system clock and/or an operation clock to count a predetermined period of time and/or an amount of time which has elapsed from a certain start time. For example, the timer may be configured to count a reference time corresponding to each of a plurality of virtual functions. When the timer expires (for example, when the reference time elapses from a certain start time), the status manager 1310 may perform a monitoring operation, etc.

The status manager 1310 may perform the monitoring operation to generate status information. For example, the status information may include at least one of the performance of the plurality of virtual functions VF1 to VF4, the I/O pattern of the plurality of virtual functions VF1 to VF4, and/or an internal status of the storage device 1200, etc. The status manager 1310 may provide the status information to the resource manager 1320, but is not limited thereto.

The resource manager 1320 may perform at least one resource allocation operation. The resource manager 1320 may be implemented in hardware or as a combination of hardware and software. The resource allocation operation may denote an operation of allocating one or more resources to the plurality of virtual functions VF1 to VF4, etc. For example, the resources may include at least one of hardware resources, memory resources, queue resources, entries (and/or a command slot) of a command buffer, and/or interrupt vectors, etc., but is not limited thereto. The hardware resources may include a command fetch engine and/or a direct memory access (DMA) engine, etc. The queue resources may include a submission queue and/or a command queue, etc.

In at least one example embodiment, the resource manager 1320 may allocate one or more resources to the plurality of virtual functions VF1 to VF4 in real time and/or substantially real-time, but is not limited thereto. For example, the resource manager 1320 may allocate resources to the plurality of virtual functions VF1 to VF4 in real time, and/or substantially real-time, based on status information received from the status manager 1310. The resource manager 1320 may receive the status information from the status manager 1310. The resource manager 1320 may reallocate resources to one or more of the plurality of virtual functions VF1 to VF4 based on the status information. The resource manager 1320 may dynamically control resources of the plurality of virtual functions VF1 to VF4.

The storage device 1200 may dynamically allocate resources to a plurality of virtual functions, instead of uniformly distributing resources to the total and/or maximum number of virtual functions supported by and/or supportable by the storage device 1200. In a case where the storage device 1200 uniformly distributes resources to all virtual functions, resources allocated to virtual functions which are not operational (e.g., inactive, sleeping, offline, etc.) may be unused. The storage device 1200 may allocate in real time, and/or substantially real-time, resources to only virtual functions which are operating and/or operational, e.g., active, on-line, etc. The storage device 1200 may dynamically apply resources to only on-line virtual functions and may thus more efficiently manage resources of the computer system.

As described above, the storage device 1200 according to at least one example embodiment may redistribute resources to a plurality of virtual functions which are operating (e.g., active, on-line, etc.). Therefore, the storage device 1200 may more efficiently manage resources. A storage device and a storage system each having enhanced resource efficiency may be provided.

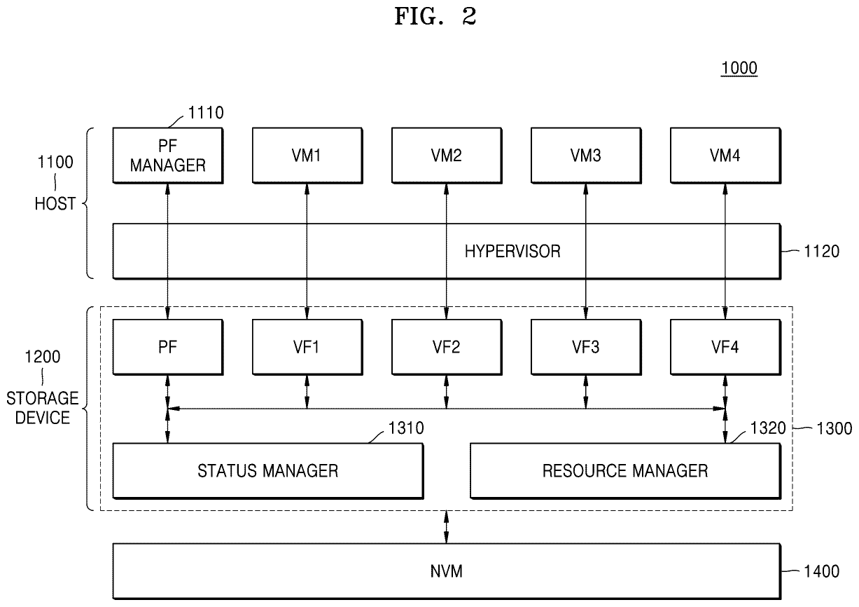

FIG. 2 is a block diagram illustrating a storage system according to at least one example embodiment.

Referring to FIGS. 1 and 2, a host device 1100 may include a physical function (PF) manager 1110, a hypervisor 1120, and/or a plurality of virtual machines, e.g., first to fourth virtual machines VM1 to VM4, etc., but the example embodiments are not limited thereto, and for example, the host device 1100 may include a greater or lesser number of virtual machines, etc. The storage device 1200 may include a storage controller 1300 and a non-volatile memory device 1400, but is not limited thereto. The storage controller 1300 may include at least one physical function PF, a plurality of virtual functions, e.g., first to fourth virtual functions VF1 to VF4, etc., a status manager 1310, and/or a resource manager 1320, etc., but the example embodiments are not limited thereto. For the sake of clarity and brevity, detailed descriptions of the elements given above with reference to FIG. 1 are omitted.

The host device 1100 may be configured to drive a plurality of virtual machines (for example, first to fourth virtual machines VM1 to VM4, etc.). Each of the plurality of virtual machines VM1 to VM4 may be independently driven in the host device 1100. The hypervisor 1120 may be a logical platform configured to drive (e.g., execute, run, etc.) the plurality of virtual machines VM1 to VM4 which are driven (e.g., executed by, run by, etc.) in the host device 1100. Each of the plurality of virtual machines VM1 to VM4 may be independently driven in the host device 1100, but are not limited thereto.

In at least one example embodiment, the PF manager 1110 may communicate with the physical function PF, and the plurality of virtual machines VM1 to VM4 may communicate with corresponding virtual functions. The PF manager 1110 may be a management host, but is not limited thereto. The virtual machines may each be a user host, but is not limited thereto. For example, the PF manager 1110 may transmit at least one management command to the physical function PF. The plurality of virtual machines VM1 to VM4 may respectively transmit at least one general command to corresponding virtual functions VF1 to VF4, etc.

The physical function PF may receive the management command and/or the general command generated by the PF manager 1110, and may process the management command and/or the general command. Each of the virtual functions VF1 to VF4 may receive the general command generated by a corresponding virtual machine of the virtual machines VM1 to VM4 and may process the general command. The virtual function VF may share physical resources, such as a link with the physical function PF, etc., and other virtual functions associated with the same physical function PF. The virtual function VF may be a lightweight PCIe function directly accessible by the virtual machine VM, but is not limited thereto.

Each of the PF manager 1110 and the plurality of virtual machines VM1 to VM4 may be configured to be accessed by the storage device 1200. The first virtual machine VM1 may correspond to the first virtual function VF1, the second virtual machine VM2 may correspond to the second virtual function VF2, the third virtual machine VM3 may correspond to the third virtual function VF4, and the fourth virtual machine VM4 may correspond to the fourth virtual function VF4, etc. In other words, the first virtual machine VM1 may communicate with the first virtual function VF1, the second virtual machine VM2 may communicate with the second virtual function VF2, the third virtual machine VM3 may communicate with the third virtual function VF4, and the fourth virtual machine VM4 may communicate with the fourth virtual function VF4, etc.

For example, the physical function PF may be a sub storage controller corresponding to the PF manager 1110, and each of the virtual functions VF1 to VF4 may be a sub storage controller corresponding to at least one of the plurality of virtual machines VM1 to VM4. However, the scope of the example embodiments of the inventive concepts are not limited thereto. Also, for convenience of description, the terms “physical function PF” and “virtual function VF” may be used, but the physical function PF and the virtual function VF may be interchangeably used with the element or term of the sub storage controller.

In at least one example embodiment, the storage device 1200 may support at least one SR-IOV function. SR-IOV may denote a function of supporting one physical function and/or one or more dependent virtual functions. The storage device 1200 may include a plurality of virtual functions and may support a multi-function. For example, it may be understood that the physical function PF and the virtual function VF are configured to process at least one command of a corresponding host (for example, a virtual machine) and/or at least one command of a transmission queue managed by the corresponding host. Hereinafter, for the sake of brevity and clarity, the storage device 1200 may be assumed to communicate with four virtual machines VM1 to VM4, but the scope of the example embodiments of the inventive concepts are not limited thereto, and the storage device 1200 may communicate with a greater or lesser number of virtual machines.

The storage device 1200 may be assumed to support 128 a plurality of virtual functions. The host device 1100 may set the number of virtual functions capable of being used based on a command, a setting, a configuration, etc. For example, the host device 1100 may set the number of virtual functions corresponding to a physical function to, e.g., 10, but is not limited thereto. The host device 1100 may, for example, use a limited number of virtual functions, e.g., four virtual functions, of the total available virtual functions, e.g., the ten virtual functions, and may not use the remaining virtual functions, e.g., the other six virtual functions, but the example embodiments are not limited thereto. Hereinafter, the host device 1100 may be assumed to use only the first to fourth virtual functions VM1 to VM4.

The plurality of virtual functions VF1 to VF4 may not have a dedicated resource. Additionally, the plurality of virtual functions VF1 to VF4 may reduce and/or prevent an increase in initial performance and/or initial latency to allocate only a small and/or limited number of dedicated resources. Most of the available resources of the system may not be allocated, and based on status information, the resource manager 1320 may allocate the resources to the plurality of virtual functions VF1 to VF4 in real time and/or substantially real-time.

The resource manager 1320 may allocate resources to the plurality of virtual functions VF1 to VF4 in real time and/or substantially real-time. In a case where the host device 1100 sets the number of virtual functions corresponding to a physical function, the resource manager 1320 may not distribute resources based on the number of set virtual functions. The resource manager 1320 may distribute resources to only the plurality of virtual functions VF1 to VF4 which are operating currently (e.g., active, on-line, etc.). Because resources are not distributed to virtual functions which are offline (and/or idle, inactive, asleep, etc.), the plurality of virtual functions VF1 to VF4 which are operating currently may process an I/O request using a relatively sufficient resource and/or an increased number of resources, etc.

In at least one example embodiment, the resource manager 1320 may set the maximum number of resources and/or the minimum number of resources of a plurality of virtual functions based on the characteristic and/or attribute of the plurality of virtual functions set by the host device 1100. For example, the resource manager 1320 may limit the maximum number of resources capable of being allocated to the first virtual function VF1 based on an attribute(s) of the first virtual function VF1. The resource manager 1320 may guarantee a minimum number of resources capable of being allocated to the first virtual function VF1 based on the attribute(s) of the first virtual function VF1, etc.

In at least one example embodiment, the host device 1100 may activate and/or deactivate a dynamic resource allocation operation of the storage device 1200. For example, the host device 1100 may transmit a first command requesting the activation of a resource allocation operation to the storage device 1200. The storage device 1200 may activate a monitoring operation on the plurality of virtual functions VF1 to VF4 in response to the first command. The storage device 1200 may activate a resource allocation operation on the plurality of virtual functions VF1 to VF4 in response to the first command.

For example, the host device 1100 may transmit a second command requesting the deactivation of the resource allocation operation to the storage device 1200. The storage device 1200 may deactivate a monitoring operation on the plurality of virtual functions VF1 to VF4 in response to the second command. The storage device 1200 may deactivate the resource allocation operation on the plurality of virtual functions VF1 to VF4 in response to the second command.

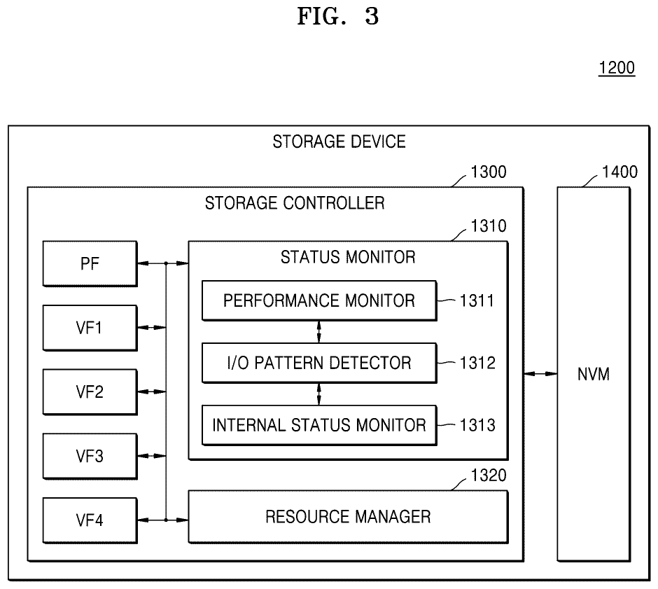

FIG. 3 is a block diagram illustrating a storage device 1200 according to at least one example embodiment.

Referring to FIGS. 1 and 3, the storage device 1200 may include at least one storage controller 1300 and at least one non-volatile memory device 1400, etc., but is not limited thereto. The storage controller 1300 may include at least one physical function PF, a plurality of virtual functions, e.g., first to fourth virtual functions VF1 to VF4, a status manager 1310, and/or a resource manager 1320, but the example embodiments are not limited thereto. The status manager 1310 may include a performance monitor 1311, an I/O pattern detector 1312, and/or an internal status monitor 1313, etc. According to some example embodiments, the storage controller 1300, physical function PF, virtual function VF, resource manager 1320, status manager 1310, performance monitor 1311, I/O pattern detector 1312, internal status monitor 1313, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The performance monitor 1311 may monitor the current performance of each of the plurality of virtual functions VF1 to VF4. The I/O pattern detector 1312 may detect an I/O pattern of each of the plurality of virtual functions VF1 to VF4. For example, the I/O pattern may include random read, random write, sequential read, sequential write, and/or a combined pattern, but is not limited thereto. The combined pattern may include at least two of random read, random write, sequential read, and sequential write, etc. The combined pattern may include information about the kind of I/O pattern and information related to a combined ratio.

The internal status monitor 1313 may monitor an internal status of the storage device 1200. The internal status may represent whether a maintenance and management operation of the non-volatile memory device 1400 being performed. The internal status may include data of the type of an internal operation (e.g., a maintenance and management operation), data of the number of internal operations, data of a level of the internal operation, and/or data of the performance of the internal operation, etc.

For example, the storage device 1200 may perform a separate maintenance and management operation (for example, garbage collection, read reclaim, bad block management, etc.) based on the physical limitations of the non-volatile memory device 1400. The maintenance and management operation may be an operation which is processed in the storage device 1200. Based on whether the maintenance and management operation described above is executed or not, an internal workload corresponding to the same commands may be changed. For example, based on the execution of a garbage collection operation, a workload corresponding to a write command may increase. The execution of the maintenance and management operation of the storage device 1200 may affect the performance serviced to the host device 1100. Due to the internal workload, the performance of a certain virtual function may be reduced. The storage device 1200 may decrease the number of resources of a plurality of virtual functions, so as to uniformly reduce the performance of the plurality of virtual functions, but is not limited thereto.

The storage device 1200 according to at least one example embodiment may consider an internal workload occurring due to the maintenance and management operation, in addition to an external workload serviced to the host device 1100, and may thus provide improved and/or uniform performance to each of the plurality of virtual machines VM1 to VM4 and/or may improve and/or increase performance.

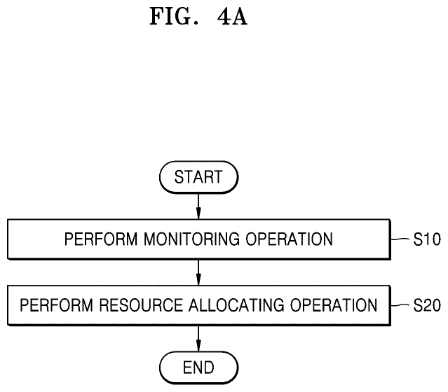

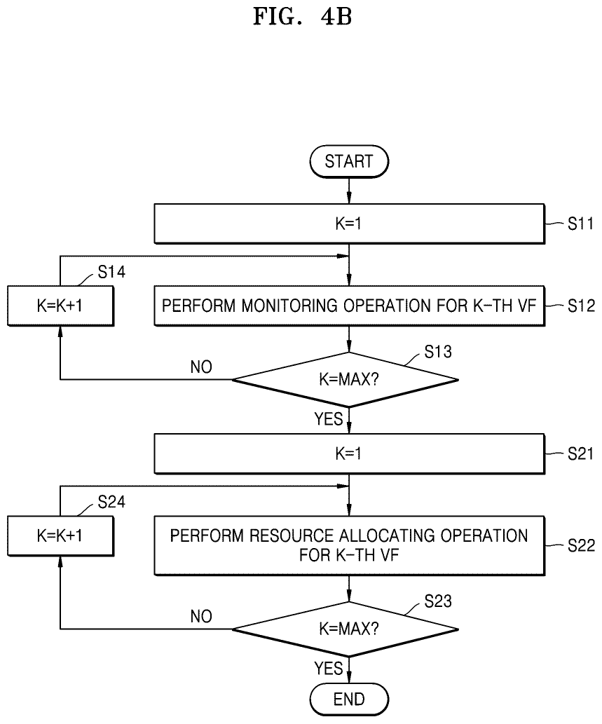

FIGS. 4A and 4B are flowcharts illustrating an example of an operating method of a storage device 1200, according to at least one example embodiment.

Referring to FIGS. 1 and 4A, in operation S10, the storage device 1200 may perform a monitoring operation. The storage device 1200 may monitor one or more parameters used in a resource allocation operation. For example, the parameter may include a performance parameter, an I/O pattern parameter, and/or an internal status parameter of the storage device 1200, etc. The storage device 1200 may perform the monitoring operation for generating status information including at least one parameter. For example, the storage device 1200 may monitor at least one of the current performance parameter of the plurality of virtual functions VF1 to VF4, the I/O pattern parameter of the plurality of virtual functions VF1 to VF4, and/or an internal status parameter of the storage device 1200, etc. The storage device 1200 may perform the monitoring operation to generate status information associated with the virtual functions VF1 to VF4 and/or the storage device 1200, etc.

In operation S20, the storage device 1200 may perform a resource allocation operation. The storage device 1200 may reallocate one or more physical resources to the plurality of virtual functions VF1 to VF4 based on the status information associated with the virtual functions VF1 to VF4 and/or the storage device 1200. For example, the storage device 1200 may reallocate at least one of hardware resource, a queue resource, an entry of a command buffer resource, and/or an interrupt vector resource, etc., to the plurality of virtual functions VF1 to VF4, but is not limited thereto.

In at least one example embodiment, the storage device 1200 may process at least one I/O request. The storage device 1200 may process the I/O request received from the host device 1100 so that each of the plurality of virtual functions VF1 to VF4 has a corresponding target performance, based on resources allocated in performing the resource allocation operation.

In at least one example embodiment, the storage device 1200 may periodically perform the monitoring operation and the resource allocation operation, but is not limited thereto. When a reference time elapses and/or when a timer is completed, the storage device 1200 may perform the monitoring operation and the resource allocation operation. When a certain condition is satisfied, the storage device 1200 may perform the monitoring operation and the resource allocation operation. Additionally, the storage device 1200 may perform the monitoring operation and the resource allocation operation in response to a request of the host device 1100.

As described above, the storage device 1200 including the plurality of virtual functions VF1 to VF4 may allocate an optimal resource to the plurality of virtual functions VF1 to VF4, based on the performance, the I/O pattern, and/or the internal status, etc., of the storage device 1200. Accordingly, a storage system having enhanced and/or improved performance may be provided.

Referring to FIG. 4B, in at least one example embodiment, operation S10 may include operations S11 to S14, and operation S20 may include operations S21 to S24. In operation S11, a variable k may be set to 1. For example, the variable k may be used for describing the repetition of the monitoring operation on a plurality of virtual functions, but the scope of the example embodiments of the inventive concepts are not limited thereto.

In operation S12, the storage device 1200 may perform the monitoring operation on a kth virtual function of the plurality of virtual functions VF1 to VF4. For example, the storage device 1200 may monitor an I/O pattern corresponding to the kth virtual function.

In operation S13, whether the variable k is a maximum value, or in other words, the variable k has reached a threshold value, may be determined. For example, because the storage device 1200 includes the first to fourth virtual functions VF1 to VF4, the maximum value and/or threshold value may be 4, but is not limited thereto. In at least one example embodiment, the maximum value and/or threshold value may be the number of virtual functions set by the host device 1100, but is not limited thereto. When the variable k is not the maximum value and/or is under the threshold value, the storage device 1200 may perform operation S14, and when the variable k is the maximum value and/or has reached the threshold value, the storage device 1200 may perform operation S21.

In operation S14, the variable k may increase by 1 in response to the completion of the previous operation. Subsequently, the storage device 1200 may perform an operation of operation S12. The storage device 1200 may repeatedly perform a monitoring operation on virtual functions which are operating.

In operation S21, the variable k may be set to 1. For example, the variable k may be used for describing the repetition of the monitoring operation on a plurality of virtual functions, but the scope of the example embodiments of the inventive concepts are not limited thereto.

In operation S22, the storage device 1200 may perform the resource allocation operation on the kth virtual function of the plurality of virtual functions VF1 to VF4. For example, the storage device 1200 may adjust at least one resource corresponding to the kth virtual function in real time and/or substantially real time, based on a monitoring result.

In operation S23, whether the variable k is the maximum value and/or has reached the threshold value may be determined. For example, because the storage device 1200 includes the first to fourth virtual functions VF1 to VF4, the maximum value may be 4, but is not limited thereto. In at least one example embodiment, the maximum value may be the number of virtual functions set by the host device 1100, but is not limited thereto, and may be greater or lesser than the number of virtual functions set by the host device 1100. When the variable k is not the maximum value, e.g., the variable k is less than the threshold value, the storage device 1200 may perform operation S24.

In operation S24, the variable k may increase by 1 in response to the completion of the previous operation. Subsequently, the storage device 1200 may perform an operation of operation S22. The storage device 1200 may repeatedly perform the resource allocation operation on virtual functions which are operating.

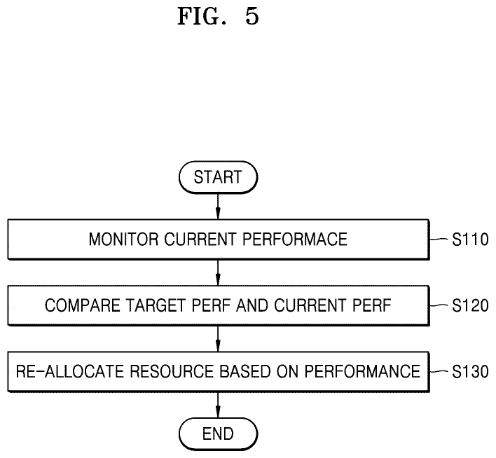

FIG. 5 is a flowchart illustrating an example of an operating method of a storage device 1200, according to at least one example embodiment.

Referring to FIGS. 1, 4, and 5, operation S110 may correspond to operation S10 of FIG. 4, and operation S120 and operation S130 may correspond to operation S20 of FIG. 4.

In operation S110, the storage device 1200 may monitor current performance of the storage device 1200, including, for example, the performance of the plurality of virtual functions VF1 to VF4, etc. In at least one example embodiment, the performance monitor 1311 may monitor the current performance of each of the plurality of virtual functions VF1 to VF4, etc. The performance monitor 1311 may generate status information associated with the storage device 1200, the status information including the monitored current performance of each of the plurality of virtual functions VF1 to VF4. The performance monitor 1311 may provide the status information to the resource manager 1320.

In at least one example embodiment, the performance monitor 1311 may periodically monitor the current performance of each of the plurality of virtual functions VF1 to VF4. The performance monitor 1311 may continuously monitor and/or monitor the current performance of each of the plurality of virtual functions VF1 to VF4. Additionally, the performance monitor 1311 may monitor the current performance of at least one of the plurality of virtual functions VF1 to VF4. For example, when a first reference time of the first virtual function VF1 elapses and a timer is completed, the performance monitor 1311 may monitor the current performance of the first virtual function VF1, etc.

In operation S120, the storage device 1200 may compare the current performance of the storage device 1200 and/or one or more of the virtual functions VF1 to VF4 with a target performance corresponding to the storage device 1200 and/or one or more of the virtual functions VF1 to VF4, etc. For example, the storage device 1200 may receive the target performance of each of the plurality of virtual functions VF1 to VF4 from corresponding virtual machines VM1 to VM4 during an initialization operation, but is not limited thereto. The storage device 1200 may store the target performance of each of the plurality of virtual functions VF1 to VF4 in a memory.

For example, the first virtual machine VM1 may transmit the target performance of the first virtual function VF1 to the storage device 1200. The storage device 1200 may store the target performance of the first virtual function VF1 in the memory. The storage device 1200 may receive status information from the status manager 1310. The storage device 1200 may receive the current performance of each of the plurality of virtual functions VF1 to VF4. The storage device 1200 may compare the current performance of each of the plurality of virtual functions VF1 to VF4 with the corresponding target performance of the plurality of virtual functions VF1 to VF4.

In at least one example embodiment, the resource manager 1320 may generate a comparison result based on the current performance of each of the plurality of virtual functions VF1 to VF4 and the target performance of the plurality of virtual functions VF1 to VF4. The comparison result may include data of a status of the current performance and data of the performance difference. The data of the status of the current performance may represent whether the current performance is greater than the target performance, whether the current performance is less than the target performance, or whether the current performance is equal to or similar to the target performance. The data of the performance difference may represent the difference between the target performance and the current performance.

For example, the resource manager 1320 may compare first target performance of the first virtual function VF1 with first current performance of the first virtual function VF1. The resource manager 1320 may determine whether the first current performance is greater than the first target performance, whether the first current performance is less than the first target performance, or whether the first current performance is equal or similar to the first target performance. The resource manager 1320 may generate data of a status of current performance of the first virtual function VF1. The resource manager 1320 may calculate the difference between the first current performance and the first target performance. The resource manager 1320 may detect the difference between the first current performance and the first target performance. The resource manager 1320 may generate data of the performance difference of the first virtual function VF1. The resource manager 1320 may generate a comparison result which includes, e.g., the data of the status of the current performance of the first virtual function VF1 and the data of the performance difference of the first virtual function VF1.

In operation S130, the storage device 1200 may reallocate and/or reassign a resource based on the results of the performance comparison of the first virtual function VF1. The storage device 1200 may adjust a physical resource based on the comparison result. For example, the storage device 1200 may adjust one or more of a hardware resource, a queue resource, an entry of a command buffer, and/or an interrupt vector to the plurality of virtual functions VF1 to VF4 based on the comparison result, etc.

For example, when the first current performance of the first virtual function VF1 is lower than the first target performance of the first virtual function VF1, the resource manager 1320 may increase the number of physical resources allocated to the first virtual function VF1. When a first current performance of the fourth virtual function VF4 is lower than a fourth target performance of the fourth virtual function VF4, the resource manager 1320 may increase the number of physical resources of the fourth virtual function VF4, etc.

In at least one example embodiment, the storage device 1200 may perform operations S110 to S130 on all of the plurality of virtual functions VF1 to VF4. Additionally, the storage device 1200 may perform operations S110 to S130 on at least one of the plurality of virtual functions VF1 to VF4.

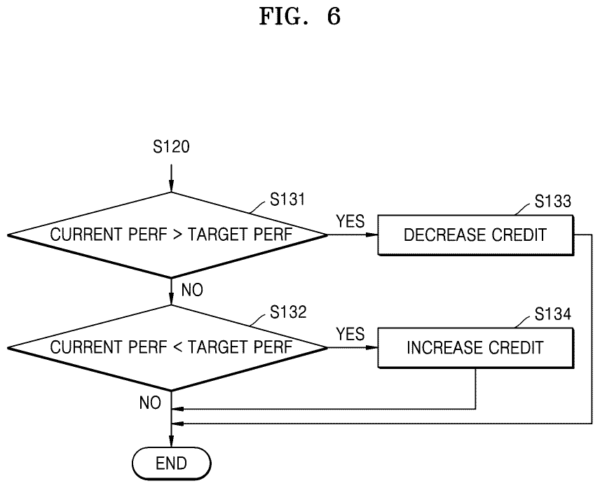

FIG. 6 is a flowchart illustrating in more detail operation S130 of FIG. 5.

Referring to FIGS. 1, 5, and 6, operation S130 of FIG. 5 may include operations S131 to S134. The storage device 1200 may allocate physical resources to the plurality of virtual functions VF1 to VF4, based on the performance comparison results associated with the plurality of virtual functions VF1 to VF4. In operation S131, the storage device 1200 may compare the current performance of a virtual function with target performance of the virtual function. For example, the storage device 1200 may determine whether the first current performance of the first virtual function VF1 is higher than the first target performance of the first virtual function VF1. In at least one example embodiment, the storage device 1200 may determine whether the data of the status of the current performance represents a case where the current performance is higher than the target performance. When the current performance is higher than the target performance, the storage device 1200 may perform operation S133, and when the current performance is not higher than the target performance, the storage device 1200 may perform operation S132.

In operation S132, the storage device 1200 may determine whether the current performance is lower than the target performance. For example, the storage device 1200 may determine whether the first current performance of the first virtual function VF1 is lower than the first target performance of the first virtual function VF1. In at least one example embodiment, the storage device 1200 may determine whether the data of the status of the current performance of the virtual function represents a case where the current performance of the virtual function is lower than the target performance of the virtual function. When the current performance of the virtual function is lower than the target performance of the virtual function, the storage device 1200 may perform operation S134, and when the current performance is not lower than the target performance, the storage device 1200 may not change a credit associated with the virtual function, or in other words, maintains the credit (e.g., the resources allocated to the virtual function) of the virtual function.

In operation S133, the storage device 1200 may decrease the credit of the virtual function. The credit may represent the number of entries of the command buffer capable of storing a command received from the host device 1110, but is not limited thereto. For example, when the first current performance of the first virtual function VF1 is higher than the first target performance of the first virtual function VF1, the resource manager 1320 may decrease the credits of the first virtual function VF1. That is, the resource manager 1320 may decrease the number of entries of the command buffer allocated to the first virtual function VF1, etc.

In operation S134, the storage device 1200 may increase the credit of the virtual function. For example, when the first current performance of the first virtual function VF1 is lower than the first target performance of the first virtual function VF1, the resource manager 1320 may increase the credit of the first virtual function VF1. That is, the resource manager 1320 may increase the number of entries of the command buffer allocated to the first virtual function VF1, etc.

As described above, the storage device 1200 according to at least one example embodiment may dynamically adjust credits of a plurality of virtual functions, based on status information of the plurality of virtual functions, the status information including monitored performance information of the plurality of virtual functions. Accordingly, the storage device 1200 may more efficiently manage resources of the storage device 1200 and may provide improved processing of I/O requests to the host device 1100 and/or improved performance of storage device 1200 based on target performance of the virtual functions.

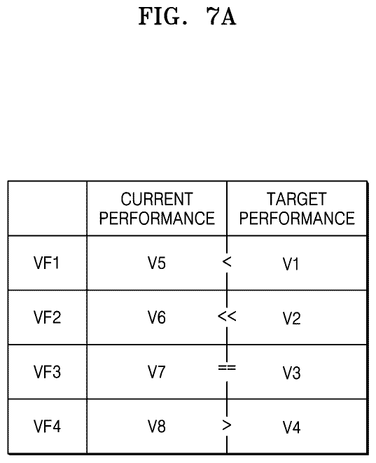

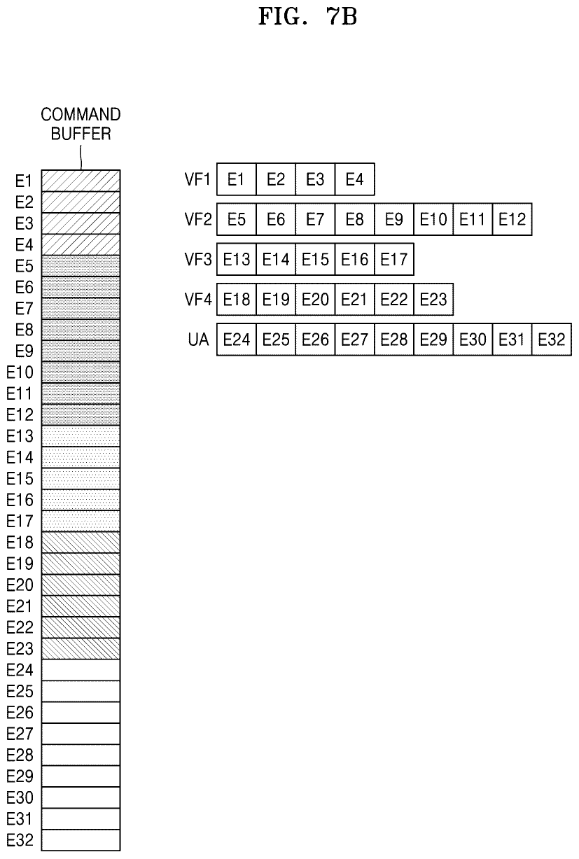

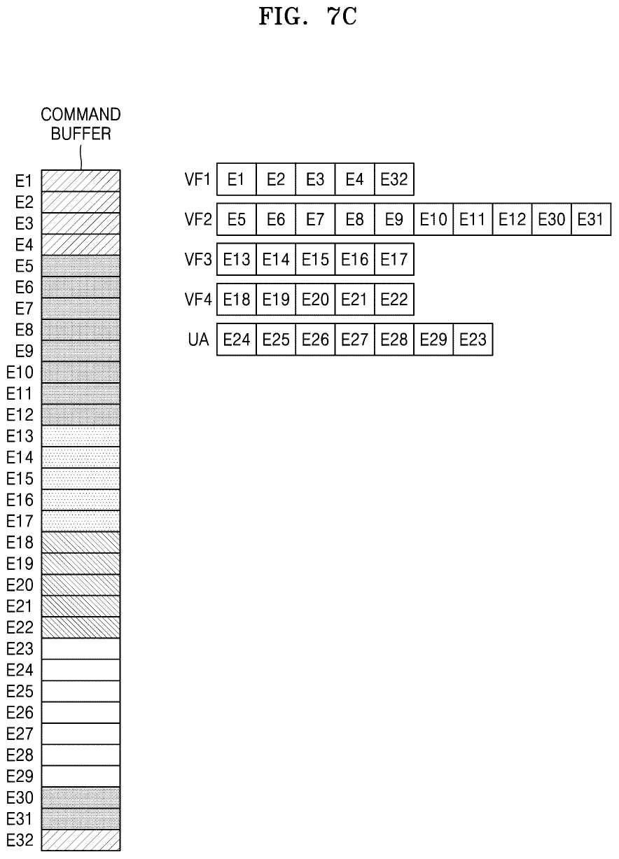

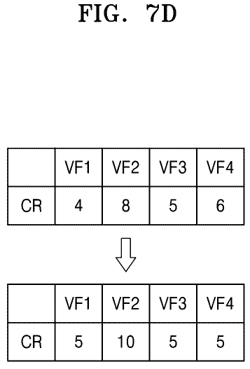

FIGS. 7A to 7D are diagrams for describing an operating method of a storage device, according to at least one example embodiment.

Referring to FIG. 7A, the storage device 1200 may receive target performance of a plurality of virtual functions, for example, first to fourth virtual functions VF1 to VF4, from the host device 1100. For example, a first virtual machine VM1 executing on the host device 1100 may provide first target performance of the first virtual function VF1, a second virtual machine VM2 may provide second target performance of the second virtual function VF2, a third virtual machine VM3 may provide third target performance of the third virtual function VF3, and/or a fourth virtual machine VM4 may provide fourth target performance of the fourth virtual function VF4, etc. The storage device 1200 may store the target performance of each of the plurality of virtual functions VF1 to VF4 in a memory. For example, the first target performance of the first virtual function VF1 may be a first value V1, the second target performance of the second virtual function VF2 may be a second value V2, the third target performance of the third virtual function VF3 may be a third value V3, and/or the fourth target performance of the fourth virtual function VF4 may be a fourth value V4, etc.

The performance monitor 1311 may perform at least one monitoring operation to generate status information associated with and/or corresponding to the storage device 1200 and/or the plurality of virtual functions, etc. The status information may include current performance of each of the plurality of virtual functions VF1 to VF4, etc. For example, the first current performance of the first virtual function VF1 may be a fifth value V5, the second current performance of the second virtual function VF2 may be a sixth value V6, the third current performance of the third virtual function VF3 may be a seventh value V7, and/or the fourth current performance of the fourth virtual function VF4 may be an eighth value V8, etc.

For example, the first value V1 may be greater than the fifth value V5, the second value V2 may be greater than the sixth value V6, the third value V3 may be equal or similar to the seventh value V7, and the fourth value V4 may be less than the eighth value V8, but the example embodiments are not limited thereto.

In at least one example embodiment, the command buffer may include first to thirty-second entries E1 to E32. However, the scope of the example embodiments of the inventive concepts are not limited thereto, and based on an implementation type, a structure of the command buffer and the number of entries of the command buffer may be changed.

FIG. 7B illustrates a command buffer before a resource allocation operation is performed, and FIG. 7C illustrates a command buffer after the resource allocation operation is performed, but the example embodiments are not limited thereto. Referring to FIG. 7B, in an initialization operation, the storage device 1200 may allocate a credit based on target performance values of each of a plurality of virtual functions VF1 to VF4 received. For example, the resource manager 1320 may distribute entries of the command buffer based on the target performance values of each of the plurality of virtual functions VF1 to VF4, but the example embodiments are not limited thereto. For example, the resource manager 1320 may allocate the first to fourth entries E1 to E4 to the first virtual function VF1, etc. The resource manager 1320 may allocate the fifth to twelfth entries E5 to E12 to the second virtual function VF2, etc. The resource manager 1320 may allocate the thirteenth to seventeenth entries E13 to E17 to the third virtual function VF3, etc. The resource manager 1320 may allocate the eighteenth to twenty-third entries E18 to E23 to the fourth virtual function VF4, etc. The twenty-fourth to thirty-second entries E24 to E32 may be unallocated entries.

For example, the first to fourth entries E1 to E4 may be allocated to the first virtual function VF1, and thus, the first virtual function VF1 may store commands and/or requests received from the first virtual machine VM1 in the first to fourth entries E1 to E4. The fifth to twelfth entries E5 to E12 may be allocated to the second virtual function VF2, and thus, the second virtual function VF2 may store commands and/or requests received from the second virtual machine VM2 in the fifth to twelfth entries E5 to E12. The thirteenth to seventeenth entries E13 to E17 may be allocated to the third virtual function VF3, and thus, the third virtual function VF3 may store commands and/or requests received from the third virtual machine VM3 in the thirteenth to seventeenth entries E13 to E17. The eighteenth to twenty-third entries E18 to E23 may be allocated to the fourth virtual function VF4, and thus, the fourth virtual function VF4 may store commands and/or requests received from the fourth virtual machine VM4 in the eighteenth to twenty-third entries E18 to E23.

Because the first to fourth entries E1 to E4 are allocated to the first virtual function VF1, the first virtual function VF1 may simultaneously process four commands, but is not limited thereto, and for example, the first virtual function VF1 may process the four commands non-simultaneously. The first virtual function VF1 may store the commands received from the first virtual machine VM1 in one of the allocated entries for the first virtual function VF1. The first virtual function VF1 may process the received command and may transfer a response to the first virtual machine VM1, and then, may delete the processed command stored in an entry of the command buffer.

That is, the first virtual function VF1 may store a first command in the first entry E1, store a second command in the second entry E2, store a third command in the third entry E3, and store a fourth command in the fourth entry E4. Because there is no empty entry, the first virtual function VF1 may no longer receive additional commands from the first virtual machine VM1 without first processing and/or deleting one of the existing commands. The first virtual function VF1 may process one (for example, the first command) of the first to fourth commands and may transfer a corresponding response to the first virtual machine VM1. The first virtual function VF1 may transfer to the first virtual machine VM1 a response to the first command, and then, may use the first entry E1 for a new command. When there is an empty entry of the entries allocated to the command buffer, the first virtual function VF1 may receive a new command from the first virtual machine VM1. Because the first entry E1 is empty, the first virtual function VF1 may receive a fifth command and may store the fifth command in the first entry E1, etc.

Referring to FIG. 7C, the fifth value V5 may be less than the first value V1, namely, the first current performance of the first virtual function VF1 may be lower than the first target performance of the first virtual function VF1, and thus, the resource manager 1320 may increase the number of entries of the command buffer allocated to and/or assigned to the first virtual function VF1. That is, the resource manager 1320 may further allocate at least one additional entry of the command buffer to the first virtual function VF1. For example, the resource manager 1320 may allocate at least one (for example, the thirty-second entry E32) of the unallocated entries (for example, the twenty-fourth to thirty-second entries E24 to E32) to the first virtual function VF1. Accordingly, the number of entries of the command buffer allocated to the first virtual function VF1 may increase. The first to fourth entries E1 to E4 and the thirty-second entry E32 may be assigned to the first virtual function VF1, etc.

The sixth value V6 may be less than the second value V2, namely, the second current performance of the second virtual function VF2 may be lower than the second target performance of the second virtual function VF2, and thus, the resource manager 1320 may increase the number of entries of the command buffer allocated to and/or assigned to the second virtual function VF2. That is, the resource manager 1320 may further allocate at least one entry of the command buffer to the second virtual function VF2. For example, the resource manager 1320 may allocate at least one (for example, the thirtieth and thirty-first entries E30 and E31) of the unallocated entries (for example, the twenty-fourth to thirty-first entries E24 to E31) to the second virtual function VF2. Accordingly, the number of entries of the command buffer allocated to the second virtual function VF2 may increase. The fifth to twelfth entries E5 to E12, the thirtieth entry E30, and the thirty-first entry E31 may be assigned to the second virtual function VF2, etc.

The seventh value V7 may be equal to, or similar to, the third value V3, namely, the third current performance of the third virtual function VF3 may be equal to, or similar to, the third target performance of the third virtual function VF3, and thus, the resource manager 1320 may not adjust (and/or may maintain) the current number of entries allocated to and/or assigned to the command buffer of the third virtual function VF3. The third virtual function VF3 may process I/O requests within the third target performance value and/or may satisfy the third target performance value, and thus, the resource manager 1320 may increase or may not decrease (e.g., maintain) the number of resources assigned to the third virtual function VF3, etc. The resource manager 1320 may not change a physical resource allocated to the third virtual function VF3. For example, the resource manager 1320 may not adjust (e.g., may maintain) the number of entries of the command buffer allocated to the third virtual function VF3. The thirteenth to seventeenth entries E13 to E17 may be assigned to the third virtual function VF3, which is identical to the resources allocated to the third virtual function VF3 before a resource allocation operation was performed.

The eighth value V8 may be greater than the fourth value V4, namely, the fourth current performance of the fourth virtual function VF4 may be higher than the fourth target performance of the fourth virtual function VF4, and thus, the resource manager 1320 may decrease the number of entries of the command buffer allocated to and/or assigned to the fourth virtual function VF4. That is, the resource manager 1320 may retrieve (and/or collect, deallocate, reassign, etc.) at least one entry of the command buffer from the fourth virtual function VF4. For example, the resource manager 1320 may retrieve at least one (for example, the twenty-third entry E23) of the entries (for example, the eighteenth to twenty-third entries E18 to E23) allocated to the fourth virtual function VF4, but is not limited thereto. Accordingly, the number of entries of the command buffer allocated to the fourth virtual function VF4 may decrease. The eighteenth to twenty-second entries E18 to E22 may be assigned to the fourth virtual function VF4. The twenty-third to twenty-ninth entries E24 to E29 may be unallocated entries.

Referring to FIG. 7D, before a resource allocation operation is performed, the first to fourth entries E1 to E4 may be allocated to the first virtual function VF1, and thus, the credit of the first virtual function VF1 may be ‘4’. The resource manager 1320 may additionally allocate the thirty-second entry E32 to the first virtual function VF1 through the resource allocation operation. After the resource allocation operation is performed, the first, second, third, fourth, and thirty-second entries E1 to E4 and E32 may be allocated to the first virtual function VF1, and thus, the credit of the first virtual function VF1 may be ‘5’. That is, the credit of the first virtual function VF1 may increase by ‘1’ from ‘4’ to ‘5’.

Before the resource allocation operation is performed, the fifth to twelfth entries E5 to E12 may be allocated to the second virtual function VF2, and thus, the credit of the second virtual function VF2 may be ‘8’. The resource manager 1320 may additionally allocate the thirtieth and thirty-first entries E30 and E31 to the second virtual function VF2 through the resource allocation operation. After the resource allocation operation is performed, the fifth, sixth, seventh, eighth, ninth, tenth, eleventh, twelfth, thirtieth, and thirty-first entries E5 to E12, E30, and E31 may be allocated to the second virtual function VF2, and thus, the credit of the second virtual function VF2 may be ‘10’. That is, the credit of the second virtual function VF2 may increase by ‘2’ from ‘8’ to ‘10’.

Before the resource allocation operation is performed, the thirteenth to seventeenth entries E13 to E17 may be allocated to the third virtual function VF3, and thus, the credit of the third virtual function VF3 may be ‘5’. The resource manager 1320 may not adjust the number of physical resources of the third virtual function VF3 through the resource allocation operation. That is, the resource manager 1320 may increase or may not decrease (e.g., may maintain) the credit of the third virtual function VF3. The resource manager 1320 may identically maintain the credit of the third virtual function VF3. After the resource allocation operation is performed, the thirteenth to seventeenth entries E13 to E17 may be allocated to the third virtual function VF3, and thus, the credit of the third virtual function VF3 may be ‘5’. That is, the credit of the third virtual function VF3 may be maintained at ‘5’.

Before the resource allocation operation is performed, the eighteenth to twenty-third entries E18 to E23 may be allocated to the fourth virtual function VF4, and thus, the credit of the fourth virtual function VF4 may be ‘6’. The resource manager 1320 may retrieve (e.g., deallocate) the twenty-third entry E23 from the fourth virtual function VF4 through the resource allocation operation. After the resource allocation operation is performed, the eighteenth to twenty-second entries E18 to E22 may be allocated to the fourth virtual function VF4, and thus, the credit of the fourth virtual function VF4 may be ‘5’. That is, the credit of the fourth virtual function VF4 may decrease by ‘1’ from ‘6’ to ‘5’.

In at least one example embodiment, the resource manager 1320 may perform the resource allocation operation based on the difference between the current performance associated with the virtual function and the target performance associated with the virtual function. The resource manager 1320 may adjust the number of physical resources allocated to the plurality of virtual functions VF1 to VF4, based on the difference between the current performance and the target performance of the respective virtual function. The resource manager 1320 may adjust the number of entries of a command buffer allocated to the plurality of virtual functions VF1 to VF4, based on data of the performance difference of the virtual functions. The resource manager 1320 may adjust credits of the plurality of virtual functions VF1 to VF4 in real time, based on the data of the performance difference, but is not limited thereto. The number of decreased or increased credits may be proportional to the difference between the current performance of each of the plurality of virtual functions VF1 to VF4 and corresponding target performance, but is not limited thereto.

For example, because the first current performance of the first virtual function VF1 is lower than the first target performance of the first virtual function VF1, the resource manager 1320 may increase the credit of the first virtual function VF1. The resource manager 1320 may determine the amount of credit increased based on the difference between the first current performance of the first virtual function VF1 and the first target performance of the first virtual function VF1. The resource manager 1320 may further allocate the thirty-second entry E32 to the first virtual function VF1, based on a first difference, which is the difference between the first value V1 and the fifth value V5, but is not limited thereto.

Because the second current performance of the second virtual function VF2 is lower than the second target performance of the second virtual function VF2, the resource manager 1320 may increase the credit of the second virtual function VF2. The resource manager 1320 may determine the amount of credit increased based on the difference between the second current performance of the second virtual function VF2 and the second target performance of the second virtual function VF2. The resource manager 1320 may further allocate the thirtieth and thirty-first entries E30 and E31 to the second virtual function VF2, based on a second difference, which is the difference between the second value V2 and the sixth value V6, etc.

The second difference may be greater than the first difference, but is not limited thereto. For example, the second difference may be two times the first difference, etc. Accordingly, an increased credit (for example, ‘2’) of the second virtual function VF2 may be two times an increased credit (for example, ‘1’) of the first virtual function VF1.

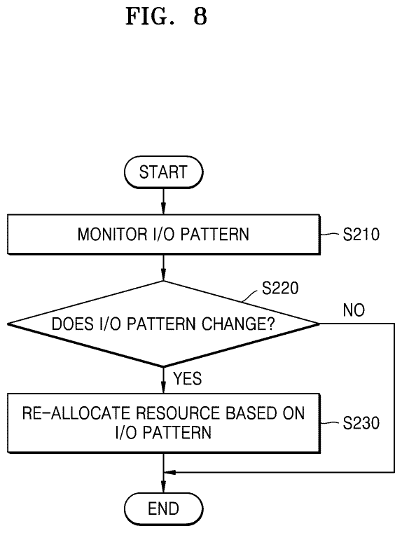

FIG. 8 is a flowchart illustrating an example of an operating method of a storage device, according to at least one example embodiment.

Referring to FIGS. 1, 4, and 8, operation S210 may correspond to operation S10 of FIG. 4, and operation S220 and operation S230 may correspond to operation S20 of FIG. 4.

In operation S210, the storage device 1200 may detect an I/O pattern. In at least one example embodiment, the I/O pattern detector 1312 may monitor a current I/O pattern of each of the plurality of virtual functions VF1 to VF4. The I/O pattern detector 1312 may determine a workload of each of the plurality of virtual machines VM1 to VM4. The I/O pattern detector 1312 may determine a current I/O pattern of each of the plurality of virtual functions VF1 to VF4 as one of, e.g., random read, random write, sequential read, sequential write, and/or combined patterns, etc.

In at least one example embodiment, the I/O pattern detector 1312 may generate status information, including the current I/O pattern, of each of the plurality of virtual functions VF1 to VF4. The I/O pattern detector 1312 may transmit the status information to the resource manager 1320.

In operation S220, the storage device 1200 may determine whether an I/O pattern of a virtual function is changed and/or has changed. The storage device 1200 may determine whether a previous I/O pattern of the virtual function differs from the current I/O pattern of the virtual function. When the I/O pattern is changed and/or different, the storage device 1200 may perform operation S230, and when the I/O pattern is not changed (e.g., the I/O pattern is the same, or substantially the same), the storage device 1200 may not reallocate resources (e.g., may maintain the allocated resources). That is, when the previous I/O pattern differs from the current I/O pattern, the storage device 1200 may perform operation S230, and when the previous I/O pattern is the same as the current I/O pattern, the storage device 1200 may not adjust resources.

For example, the storage device 1200 may determine whether an I/O pattern of each of the plurality of virtual functions VF1 to VF4 has changed. The storage device 1200 may determine whether the I/O pattern of each of the plurality of virtual functions VF1 to VF4 has changed based on the previous I/O pattern and the current I/O pattern of the respective virtual function. In at least one example embodiment, the resource manager 1320 may determine whether an I/O pattern is changed of each of a plurality of virtual function VF1 to VF4 based on the previous I/O pattern of each of the plurality of virtual functions VF1 to VF4 stored in a memory and the current I/O pattern of each of the plurality of virtual functions VF1 to VF4 included in the status information, etc. The previous I/O pattern may represent an I/O pattern which is stored during a previous resource allocation operation.

For example, in order to reallocate a resource when an I/O pattern of the first virtual function VF1 is changed, the storage device 1200 may determine whether the I/O pattern of the first virtual function VF1 has changed. The storage device 1200 may use a first previous I/O pattern of the first virtual function VF1 stored in the memory and a first current I/O pattern of the first virtual function VF1 included in the status information. The storage device 1200 may determine whether the first previous I/O pattern of the first virtual function VF1 differs from the first current I/O pattern of the first virtual function VF1. When the first previous I/O pattern is the same as the first current I/O pattern, the storage device 1200 may not adjust (e.g., maintain) a resource of the first virtual function VF1. When the first previous I/O pattern of the first virtual function VF1 differs from the first current I/O pattern of the first virtual function VF1, the storage device 1200 may adjust the resource of the first virtual function VF1.

In operation S230, the storage device 1200 may reallocate at least one resource based on the I/O pattern of a virtual function. For example, the storage device 1200 may adjust a physical resource based on a change in the previous I/O pattern and a change in the current I/O pattern of the virtual function. For example, the storage device 1200 may adjust at least one of hardware resource, a queue resource, a memory resource, an entry of a command buffer, and/or an interrupt vector of each of the plurality of virtual functions VF1 to VF4, etc., based on the change in the previous I/O pattern and the change in the current I/O pattern of the virtual function.

For example, when the I/O pattern of the first virtual function VF1 is changed to an I/O pattern which further desires and/or requires a physical resource, the resource manager 1320 may increase the number of resources allocated to the first virtual function VF1. Additionally, the resource manager 1320 may increase the amount of resources allocated to the first virtual function VF1. When an I/O pattern of the second virtual function VF2 is changed to an I/O pattern which desires and/or requires less physical resources, the resource manager 1320 may decrease the number of resources allocated to the second virtual function VF2. Additionally, the resource manager 1320 may decrease the amount of resources of the second virtual function VF2, etc.

In at least one example embodiment, the resource manager 1320 may adjust resources of only virtual functions where the I/O patterns have changed from the plurality of virtual functions VF1 to VF4. For example, the I/O pattern of the first virtual function VF1 may be changed from sequential read to random read, and the I/O patterns of the other virtual functions VF2 to VF4 may not be changed (e.g., may be the same). The resource manager 1320 may adjust only the resource of the first virtual function VF1, etc.

In at least one example embodiment, the storage device 1200 may perform operations S210 to S230 on all of the plurality of virtual functions VF1 to VF4, but is not limited thereto. Additionally, the storage device 1200 may perform operations S210 to S230 on at least one of the plurality of virtual functions VF1 to VF4.

In at least one example embodiment, after operation S230, the storage device 1200 may store the monitored current I/O pattern of a virtual function as a previous I/O pattern of the virtual function in the memory. To use the previous I/O pattern in a resource allocation operation which is to be performed subsequently, a current I/O pattern of each of the plurality of virtual functions VF1 to VF4 may be stored as the previous I/O pattern of the virtual functions VF1 to VF4 in the memory.

As described above, the resource manager 1320 may allocate resources to the plurality of virtual functions VF1 to VF4 based on the I/O pattern of the respective virtual functions VF1 to VF4. The I/O pattern may further include 1) random read, 2) random write, 3) sequential read, and/or sequential write in order, but is not limited thereto. The resource manager 1320 may further allocate a resource to a virtual function having an I/O pattern which further desires and/or requires additional resources.

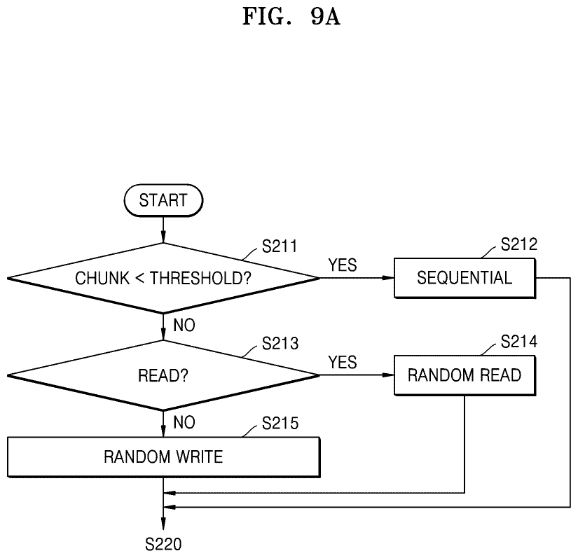

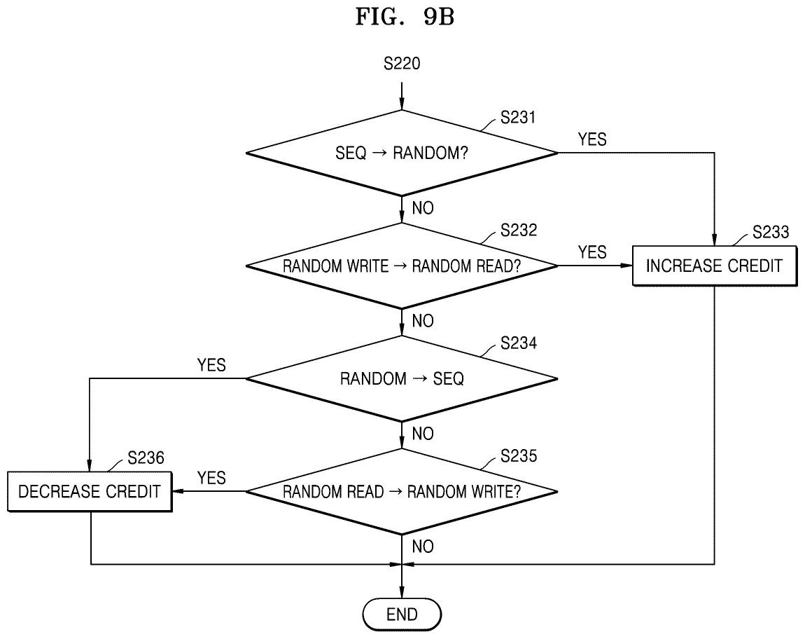

FIG. 9A is a flowchart illustrating in more detail an operation S210 of FIG. 8.

Referring to FIGS. 1, 8, and 9A, operation S210 of FIG. 8 may include operations S211 to S215. In at least one example embodiment, the storage device 1200 may monitor I/O patterns of a plurality of virtual functions. The storage device 1200 may monitor I/O patterns to determine the I/O patterns of the plurality of virtual functions. In at least one example embodiment, the storage device 1200 may whether an I/O pattern is a sequential or a random I/O pattern based on a size of data corresponding to an I/O command (for example, a read command and/or a write command, etc.). For example, when a size of the data corresponding to the I/O command is greater than or equal to a threshold value, the storage device 1200 may determine the I/O pattern is a sequential I/O pattern, and when a size of the data corresponding to the I/O command is less than the threshold value, the storage device 1200 may determine the I/O pattern is a random I/O pattern.

In at least one example embodiment, the storage device 1200 may determine whether the I/O pattern is the sequential or the random I/O pattern based on an address corresponding to the I/O command. When the address increases sequentially, the storage device 1200 may determine the I/O pattern is sequential, and when the address does not sequentially increase, the storage device 1200 may determine the I/O pattern is random. Hereinafter, a method of determining an I/O pattern on the basis of a size of data corresponding to an I/O command will be described. However, the scope of the example embodiments of the inventive concepts are not limited thereto.

In operation S211, the storage device 1200 may determine whether a size of a chunk of data is less than a threshold value. For example, the chunk may represent data corresponding to a memory operation, such as a read command and/or a write command, etc. In at least one example embodiment, the storage device 1200 may determine the I/O patterns of the plurality of virtual functions VF1 to VF4, based on a size of the chunk associated with the I/O command. For example, the storage device 1200 may determine whether a size of the chunk of the I/O command is less than a chunk threshold value. When a size of the chunk is less than the chunk threshold value, the storage device 1200 may perform operation S212, and when a size of the chunk is greater than or equal to the chunk threshold value, the storage device 1200 may perform operation S213.

In operation S212, the storage device 1200 may determine the I/O pattern as sequential. When a size of the chunk is greater than or equal to the chunk threshold value, the storage device 1200 may determine the I/O pattern as being sequential. For example, when it is determined that a size of a chunk of the first virtual function VF1 is greater than or equal to the chunk threshold value, the storage device 1200 may determine an I/O pattern of the first virtual function VF1 as sequential.

In operation S213, the storage device 1200 may determine whether a command is a read command. For example, the storage device 1200 may determine whether each of commands received from the first virtual function VF1 is a read command or a write command. When the received command is determined to be the read command, the storage device 1200 may perform operation S214, and when the received command is determined not to be the read command, the storage device 1200 may perform operation S215.

In operation S214, the storage device 1200 may determine the I/O pattern as including the random read operation. For example, the storage device 1200 may determine the I/O pattern of the first virtual function VF1 as the random read operation. In operation S215, the storage device 1200 may determine the I/O pattern as the random write operation. For example, the storage device 1200 may determine the I/O pattern of the first virtual function VF1 as the random write operation.

FIG. 9A illustrates an operating method of the storage device 1200 when an I/O pattern of a virtual function is one of sequential read, sequential write, random read, and/or random write, etc. However, the scope of the example embodiments of the inventive concepts are not limited thereto. For example, the storage device 1200 may determine an I/O pattern of a virtual function as one of sequential read, sequential write, random read, random write, and/or a combined I/O pattern, etc.

FIG. 9B is a flowchart illustrating in more detail operation S230 of FIG. 8.

Referring to FIGS. 1, 8, and 9B, operation S230 of FIG. 8 may include operations S231 to S236. In at least one example embodiment, the storage device 1200 may allocate one or more physical resources to the plurality of virtual functions VF1 to VF4 based on a previous I/O pattern and a current I/O pattern associated with the plurality of virtual functions VF1 to VF4. In operation S231, the storage device 1200 may determine whether an I/O pattern of the virtual function is changed from a sequential I/O pattern (and/or command) to the random I/O pattern (and/or command). When it is determined that the I/O pattern is changed from the sequential to the random, the storage device 1200 may perform operation S233, and when it is determined that the I/O pattern is not changed from the sequential to the random, the storage device 1200 may perform operation S232.

For example, the resource manager 1320 may determine whether the I/O pattern of the first virtual function VF1 is changed from the sequential write or the sequential read to the random write or the random read, etc. That is, the resource manager 1320 may determine whether a previous I/O pattern of the first virtual function VF1 is one of the sequential write and the sequential read and a current I/O pattern of the first virtual function VF1 is one of the random write and the random read, etc.

In operation S232, the storage device 1200 may determine whether the I/O pattern is changed from the random write to the random read. When it is determined that the I/O pattern is changed from the random write to the random read, the storage device 1200 may perform operation S233, and when it is determined that the I/O pattern is not changed from the random write to the random read, the storage device 1200 may perform operation S234.

For example, the resource manager 1320 may determine whether the I/O pattern of the first virtual function VF1 is changed from the random write to the random read. That is, the resource manager 1320 may determine whether a previous I/O pattern of the first virtual function VF1 is the random write and a current I/O pattern of the first virtual function VF1 is the random read.

In operation S233, the storage device 1200 may increase a credit associated with the virtual function. For example, when the I/O pattern of the first virtual function VF1 is changed to an I/O pattern which further desires and/or needs additional physical resources, the storage device 1200 may increase the credit of the first virtual function VF1. That is, when the I/O pattern of the first virtual function VF1 is changed from the sequential to the random, or when the I/O pattern of the first virtual function VF1 is changed from the random write to the random read, etc., the storage device 1200 may increase the number of entries of a command buffer allocated to the first virtual function VF1.

In operation S234, the storage device 1200 may determine whether an I/O pattern is changed from a random I/O pattern to the sequential I/O pattern. When it is determined that the I/O pattern is changed from the random I/O pattern to the sequential I/O pattern, the storage device 1200 may perform operation S236, and when it is determined that the I/O pattern is not changed from the random I/O pattern to the sequential I/O pattern, the storage device 1200 may perform operation S235.

For example, the resource manager 1320 may determine whether the I/O pattern of the first virtual function VF1 is changed from the random write or the random read to the sequential write or the sequential read, etc. That is, the resource manager 1320 may determine whether a previous I/O pattern of the first virtual function VF1 is one of the random write and the random read and a current I/O pattern of the first virtual function VF1 is one of the sequential write and the sequential read, etc.

In operation S235, the storage device 1200 may determine whether the I/O pattern is changed from the random read to the random write. When it is determined that the I/O pattern is changed from the random read to the random write, the storage device 1200 may perform operation S236. When it is determined that the I/O pattern is not changed from the random write to the random read, the storage device 1200 may not adjust the credit of the virtual function.

For example, the resource manager 1320 may determine whether the I/O pattern of the first virtual function VF1 is changed from the random read to the random write. That is, the resource manager 1320 may determine whether the previous I/O pattern of the first virtual function VF1 is the random read and the current I/O pattern of the first virtual function VF1 is the random write.

In operation S236, the storage device 1200 may decrease the credit associated with the first virtual function VF1. For example, when the I/O pattern of the first virtual function VF1 is changed to an I/O pattern which desires and/or needs less physical resources, the storage device 1200 may decrease the credit of the first virtual function VF1. That is, when the I/O pattern of the first virtual function VF1 is changed from the random to the sequential, or when the I/O pattern of the first virtual function VF1 is changed from the random read to the random write, etc., the storage device 1200 may decrease the number of entries of the command buffer allocated to the first virtual function VF1, etc.

The flowchart of FIG. 9B illustrates an operating method of the storage device 1200 when a current I/O pattern or a previous I/O pattern is one of sequential read, sequential write, random read, and random write, etc. However, the scope of the example embodiments of the inventive concepts are not limited thereto. The current I/O pattern or the previous I/O pattern may be one of sequential read, sequential write, random read, random write, and/or a combined pattern, etc. For example, when the current I/O pattern of the first virtual function VF1 is a pattern which desires and/or needs more resources than the previous I/O pattern, the resource manager 1320 may increase the credit of the first virtual function VF1. When the current I/O pattern of the first virtual function VF1 is a pattern which desires and/or needs less resources than the previous I/O pattern, the resource manager 1320 may decrease the credit of the first virtual function VF1.

The combined pattern may include at least two of the sequential read, the sequential write, the random read, and the random write, etc. For example, the previous I/O pattern of the first virtual function VF1 may be a combined pattern including the sequential write and the sequential read, and the current I/O pattern of the first virtual function VF1 may be a combined pattern including the random write and the random read. Because the I/O pattern is changed to an I/O pattern which further desires and/or needs resources of the first virtual function VF1, the resource manager 1320 may increase the credit of the first virtual function VF1, etc.

As described above, the resource manager 1320 may dynamically allocate resources to the plurality of virtual functions VF1 to VF4 based on the status information associated with the plurality of virtual functions VF1 to VF4. The resource manager 1320 may determine whether a first I/O pattern of the first virtual function VF1 is changed. When it is determined that the first I/O pattern of the first virtual function VF1 is changed from the sequential to the random, the resource manager 1320 may increase the number of credits of the first virtual function VF1. When it is determined that the first I/O pattern of the first virtual function VF1 is changed from the random write to the random read, the resource manager 1320 may increase the number of credits of the first virtual function VF1. When it is determined that the first I/O pattern of the first virtual function VF1 is changed from the random to the sequential, the resource manager 1320 may decrease the number of credits of the first virtual function VF1. When it is determined that the first I/O pattern of the first virtual function VF1 is changed from the random read to the random write, the resource manager 1320 may decrease the number of credits of the first virtual function VF1, etc.

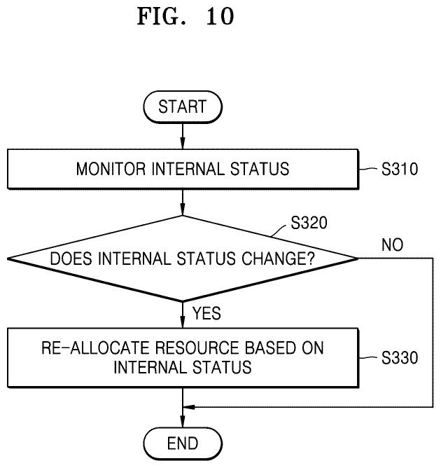

FIG. 10 is a flowchart illustrating an example of an operating method of a storage device, according to at least one example embodiment.

Referring to FIGS. 1, 4, and 10, operation S310 may correspond to operation S10 of FIG. 4, and operation S320 and operation S330 may correspond to operation S20 of FIG. 4.

In operation S310, the storage device 1200 may monitor an internal status of the storage device 1200. In at least one example embodiment, the internal status monitor 1313 may determine whether a maintenance and management operation of the non-volatile memory device 1400 included in the storage device 1200 is being performed. Additionally, the internal status monitor 1313 may determine whether an internal operation is being performed by the storage device 1200, etc. The internal operation may denote the maintenance and management operation of the non-volatile memory device 1400, etc.

In at least one example embodiment, the internal status monitor 1313 may monitor the performance of the maintenance and management operation when the maintenance and management operation is being performed. To uniformly decrease the number of resources allocated and/or assigned to the plurality of virtual functions VF1 to VF4, the internal status monitor 1313 may monitor whether the performance of the maintenance and management operation is reduced and/or discontinued, halted, etc.

The internal status monitor 1313 may generate status information including a monitored internal status of the storage device 1200, etc. The internal status monitor 1313 may generate status information including a status of an internal operation of the storage device 1200. The internal status monitor 1313 may transmit the status information to the resource manager 1320. For example, the status of the internal operation may include data of the type of the internal operation, data of the number of internal operations, and/or data of the performance of the internal operation, etc.

In at least one example embodiment, the internal status monitor 1313 may periodically monitor at least one internal status of the storage device 1200, etc. For example, the internal status monitor 1313 may monitor all of a plurality of maintenance and management operations, etc. Additionally, the internal status monitor 1313 may monitor at least one of the plurality of maintenance and management operations, etc.

In operation S320, the storage device 1200 may determine whether the internal status of the storage device 1200 is changed and/or has changed from a previous internal status of the storage device 1200, etc. The storage device 1200 may determine whether a previous internal status of the storage device 1200 differs from a current internal status of the storage device 1200. When the internal status of the storage device 1200 is changed, the storage device 1200 may perform operation S320, and when the internal status of the storage device 1200 is not changed, the storage device 1200 may not deallocate and/or reallocate resources assigned to the storage device 1200 and/or one or more of the virtual functions VF1 to VF4, etc. That is, when the previous internal status differs from the current internal status, the storage device 1200 may perform operation S320, and when the previous internal status is the same as the current internal status, the storage device 1200 may not adjust resources assigned to the plurality of virtual functions VF1 to VF4.

For example, the storage device 1200 may determine whether the internal status of the storage device 1200 is changed based on the previous internal status of the storage device 1200 and the current internal status of the storage device 1200. The resource manager 1320 may determine whether the internal status of the storage device 1200 is changed and/or has changed based on the previous internal status of the storage device 1200 stored in the memory and the current internal status of the storage device 1200 included in the status information. The previous internal status may denote an internal status which is stored in a previous resource allocation operation, but is not limited thereto.

For example, in order to reallocate one or more resources when the internal status of the storage device 1200 is changed, the storage device 1200 may determine whether the internal status of the storage device 1200 is changed. The storage device 1200 may use the previous internal status of the storage device 1200 stored in the memory and the current internal status of the storage device 1200 included in the status information. The storage device 1200 may determine whether the previous internal status of the storage device 1200 differs from the current internal status of the storage device 1200. When the previous internal status of the storage device 1200 is the same as the current internal status of the storage device 1200, the storage device 1200 may not adjust and/or may maintain the previously assigned and/or allocated resource of each of the plurality of virtual functions VF1 to VF4. When the previous internal status of the storage device 1200 differs from the current internal status of the storage device 1200, the storage device 1200 may adjust the assigned and/or allocated resources of one or more of the plurality of virtual functions VF1 to VF4.

In operation S330, the storage device 1200 may reallocate and/or deallocated resources of one or more of the plurality of virtual functions VF1 to VF4, based on the internal status of the storage device 1200, etc. For example, the storage device 1200 may adjust a physical resource assigned to and/or allocated to one or more of the virtual functions VF1 to VF4 based on the previous internal status of the storage device 1200 and a change from the previous internal status in the current internal status of the storage device 1200. For example, the storage device 1200 may adjust at least one of hardware resource, a queue resource, a memory resource, an entry of a command buffer, and/or an interrupt vector, etc., of each of the plurality of virtual functions VF1 to VF4 based on the previous internal status and the change in the current internal status.

For example, when the internal status is changed to an internal status where at least one physical resource is more needed for performing at least one internal operation of the storage device 1200, the resource manager 1320 may decrease the number of resources assigned and/or allocated to one or more of the plurality of virtual functions VF1 to VF4. When the internal status is changed to an internal status where a physical resource is less needed for performing the internal operation of the storage device 1200, the resource manager 1320 may increase the number of resources assigned to and/or allocated to one or more of the plurality of virtual functions VF1 to VF4, etc.

In at least one example embodiment, when the performance of the internal operation is reduced, the resource manager 1320 may decrease the number of resources assigned and/or allocated to one or more of the plurality of virtual functions VF1 to VF4. The resource manager 1320 may differently reduce the number of resources so that the performance of each of the plurality of virtual functions VF1 to VF4 is uniformly reduced.

In at least one example embodiment, the resource manager 1320 may adjust the assigned and/or allocated resources of each of the plurality of virtual functions VF1 to VF4 in proportion to a target performance level of one or more of the plurality of virtual functions VF1 to VF4. The resource manager 1320 may adjust the assigned and/or allocated resources of each of the plurality of virtual functions VF1 to VF4 in proportion to a corresponding resource. That is, the number of increased and/or decreased resources may be proportional to a magnitude of target performance for one or more of the virtual functions VF1 to VF4. Additionally, the number of increased and/or decreased resources may be proportional to the number of previously allocated resources to the respective virtual function VF1 to VF4, etc.

In at least one example embodiment, the storage device 1200 may perform operation S330 on all of the plurality of virtual functions VF1 to VF4. Additionally, the storage device 1200 may perform operation S330 on at least one of the plurality of virtual functions VF1 to VF4.

In at least one example embodiment, after operation S330, the storage device 1200 may store the monitored current internal status of the storage device 1200 as the previous internal status in the memory. The storage device 1200 may store the internal status of the storage device 1200 so as to use the previous internal status in a resource allocation operation which is to be performed subsequently.

As described above, based on at least one characteristic of the non-volatile memory device 1400, the storage device 1200 may further perform the internal operation, in addition to processing an I/O request received from the host device 1100. As the storage device 1200 performs the internal operation, the performance of at least one certain virtual function may be considerably reduced. To reduce and/or prevent the performance of a certain virtual function from being considerably reduced due to the internal operation and/or the maintenance and management operation, etc., the resource manager 1320 may decrease the resources assigned to one or more of the plurality of virtual functions VF1 to VF4. Accordingly, the performance of each of the plurality of virtual functions VF1 to VF4 may be uniformly reduced.

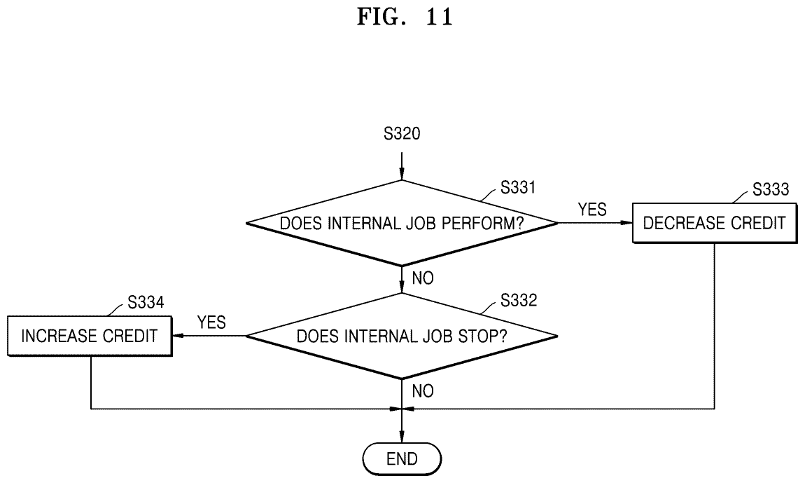

FIG. 11 is a flowchart illustrating in more detail operation S330 of FIG. 10.

Referring to FIGS. 1, 10, and 11, operation S330 of FIG. 10 may include operations S331 to S334, but is not limited thereto. The storage device 1200 may allocate one or more physical resources to one or more of a plurality of virtual functions VF1 to VF4 based on an internal status of the plurality of virtual functions VF1 to VF4. In operation S331, the storage device 1200 may determine whether an internal operation is being performed. That is, the storage device 1200 may determine whether the previous internal status represents internal operation stop and whether the current internal status represents internal operation performance. When the current internal operation is being performed, the storage device 1200 may perform operation S333, and when the current internal operation is not being performed, the storage device 1200 may perform operation S332.

In operation S332, the storage device 1200 may determine whether the internal operation stops and/or has stopped. That is, the storage device 1200 may determine whether the previous internal status represents the internal operation performance and the current internal status represents internal operation stop. When the current internal operation stops and/or has stopped, the storage device 1200 may perform operation S334, and when the current internal operation does not stop (e.g., the internal operation is continuing and/or active, etc.), the storage device 1200 may not adjust a credit of the plurality of virtual functions VF1 to VF4.

In operation S333, the storage device 1200 may decrease the credit of one or more of the plurality of virtual functions VF1 to VF4. For example, when the internal status is changed from internal operation stop to internal operation performance, the resource manager 1320 may decrease the credit of each of the plurality of virtual functions VF1 to VF4.

In operation S334, the storage device 1200 may increase the credit of one or more of the plurality of virtual functions VF1 to VF4. For example, when the internal status is changed from internal operation performance to internal operation stop, the resource manager 1320 may increase the credit of each of the plurality of virtual functions VF1 to VF4.

As described above, FIG. 11 illustrates an operating method of the storage device 1200 when each of a previous internal status and a current internal status is one of internal operation performance and internal operation stop. However, the scope of the example embodiments of the inventive concepts are not limited thereto. The previous internal status and the current internal status may represent whether an internal operation is performed and an internal operation level.

For example, the previous internal status may represent internal operation performance and a first internal operation level, and the current internal status may represent internal operation performance and a second internal operation level, etc., but is not limited thereto. It may be assumed that the first internal operation level and the second internal operation level represent the number of internal operations, and the second internal operation level is higher than the first internal operation level, etc. The second internal operation level may be more in number of operations than the first internal operation level, etc. Because the internal operation level increases, the resource manager 1320 may decrease the allocated resources of the plurality of virtual functions VF1 to VF4. Additionally, the resource manager 1320 may decrease the assigned credits of the plurality of virtual functions VF1 to VF4.

The previous internal status may represent internal operation performance and the second internal operation level, and the current internal status may represent internal operation performance and the first internal operation level, but are not limited thereto. Because the internal operation level decreases, the resource manager 1320 may increase the allocated resources of the plurality of virtual functions VF1 to VF4. Additionally, the resource manager 1320 may increase the assigned credits of the plurality of virtual functions VF1 to VF4.

In other words, when it is determined that the number of internal operations increases, the resource manager 1320 may decrease the assigned credits of each of the plurality of virtual functions VF1 to VF4. When it is determined that the number of internal operations decreases, the resource manager 1320 may increase the assigned credits of each of the plurality of virtual functions VF1 to VF4.FIGS.

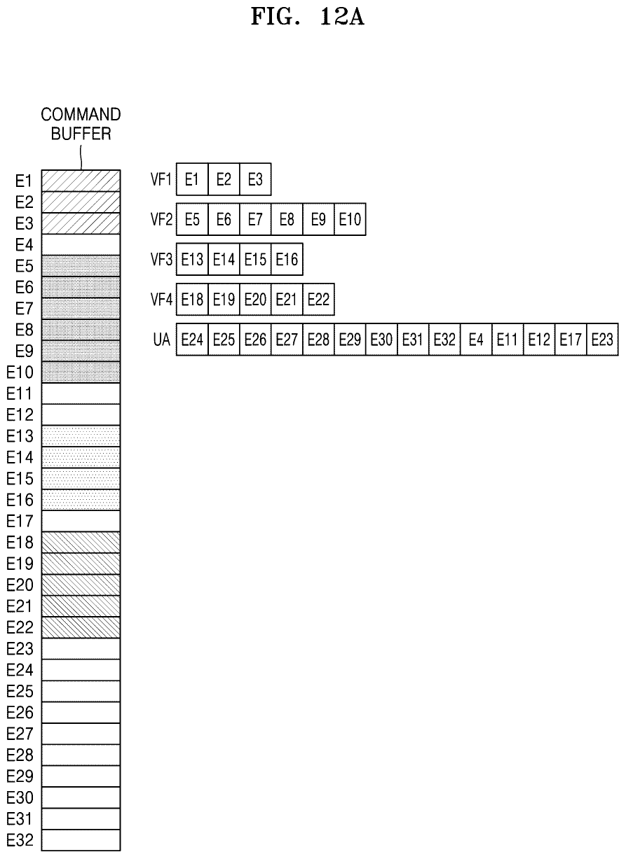

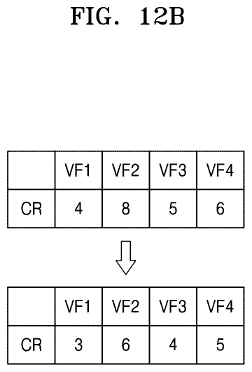

FIGS. 12A and 12B are diagrams for describing an operating method of a storage device according to at least one example embodiment. FIGS. 12A and 12B are described with reference to FIG. 7B.

FIG. 12B illustrates a command buffer before a resource allocation operation is performed, and FIG. 12A illustrates a command buffer after the resource allocation operation is performed. For the sake of brevity and clarity, a detailed description of FIG. 7B is omitted. It may be assumed that a previous internal status is internal operation stop, and a current internal status is internal operation performance.

Because the previous internal status represents the internal operation stop and the current internal status represents the internal operation performance, the resource manager 1320 may decrease resources allocated to one or more of the plurality of virtual functions. That is, because a maintenance and management operation of the non-volatile memory device 1400 is being performed, the resource manager 1320 may decrease the credits of one or more of a plurality of virtual functions, for example, first to fourth virtual functions VF1 to VF4.

For example, the resource manager 1320 may retrieve (e.g., deallocate, etc.) at least one, for example, a fourth entry E4, of a plurality of entries, for example, first to fourth entries E1 to E4, of the first virtual function VF1. The number of entries of a command buffer allocated to the first virtual function VF1 may decrease. Accordingly, the first to third entries E1 to E3 may be assigned to the first virtual function VF1.

The resource manager 1320 may retrieve (e.g., deallocate, etc.) at least one, for example, eleventh and twelfth entries E11 and E12, of a plurality of entries, for example, fifth to twelfth entries E5 to E12, of the second virtual function VF2. Accordingly, the number of entries of the command buffer allocated to the second virtual function VF2 may decrease. The fifth to tenth entries E5 to E10 may be assigned to the second virtual function VF2.

The resource manager 1320 may retrieve (e.g., deallocate, etc.) at least one, for example, a seventeenth entry E17, of a plurality of entries, for example, thirteenth to seventeenth entries E13 to E17, of the third virtual function VF3. Accordingly, the number of entries of the command buffer allocated to the third virtual function VF3 may decrease. The thirteenth to sixteenth entries E13 to E16 may be assigned to the third virtual function VF3.

The resource manager 1320 may retrieve (e.g., deallocate, etc.) at least one, for example, a twenty-third entry E23, of a plurality of entries, for example, eighteenth to twenty-third entries E18 to E23, of the fourth virtual function VF4. Accordingly, the number of entries of the command buffer allocated to the fourth virtual function VF4 may decrease. The eighteenth to twenty-second entries E18 to E22 may be assigned to the fourth virtual function VF4. The twenty-fourth, twenty-fifth, twenty-sixth, twenty-seventh, twenty-eighth, twenty-ninth, thirtieth, thirty-first, thirty-second, fourth, eleventh, twelfth, seventeenth, and twenty-third entries E24, E25, E26, E27, E28, E29, E30, E31, E32, E4, E11, E12, E17, and E23 may be unassigned entries.

Referring to FIG. 12B, before a resource allocation operation is performed, the first to fourth entries E1 to E4 may be allocated to the first virtual function VF1, and thus, a credit of the first virtual function VF1 may be ‘4’. The resource manager 1320 may retrieve (e.g., deallocate, etc.) the fourth entry E4 to the first virtual function VF1 through the resource allocation operation. After the resource allocation operation is performed, the first to third entries E1 to E3 may be allocated to the first virtual function VF1, and thus, the credit of the first virtual function VF1 may be ‘3’. That is, the credit of the first virtual function VF1 may decrease by ‘1’ from ‘4’ to ‘3’.

Before the resource allocation operation is performed, the fifth to twelfth entries E5 to E12 may be allocated to the second virtual function VF2, and thus, the credit of the second virtual function VF2 may be ‘8’. The resource manager 1320 may retrieve (e.g., deallocate, etc.) the eleventh and twelfth entries E11 and E12 from the second virtual function VF2 through the resource allocation operation. After the resource allocation operation is performed, the fifth to tenth entries E5 to E10 may be allocated to the second virtual function VF2, and thus, the credit of the second virtual function VF2 may be ‘6’. That is, the credit of the second virtual function VF2 may decrease by ‘2’ from ‘8’ to ‘6’.

Before the resource allocation operation is performed, the thirteenth to seventeenth entries E13 to E17 may be allocated to the third virtual function VF3, and thus, the credit of the third virtual function VF3 may be ‘5’. The resource manager 1320 may retrieve (e.g., deallocate, etc.) the seventeenth entry E17 from the third virtual function VF3 through the resource allocation operation. After the resource allocation operation is performed, the thirteenth to sixteenth entries E13 to E16 may be allocated to the third virtual function VF3, and thus, the credit of the third virtual function VF3 may be ‘4’. That is, the credit of the third virtual function VF3 may decrease by ‘1’ from ‘5’ to ‘4’.

Before the resource allocation operation is performed, the eighteenth to twenty-third entries E18 to E23 may be allocated to the fourth virtual function VF4, and thus, the credit of the fourth virtual function VF4 may be ‘6’. The resource manager 1320 may retrieve (e.g., deallocate, etc.) the twenty-third entry E23 from the fourth virtual function VF4 through the resource allocation operation. After the resource allocation operation is performed, the eighteenth to twenty-second entries E18 to E22 may be allocated to the fourth virtual function VF4, and thus, the credit of the fourth virtual function VF4 may be ‘5’. That is, the credit of the fourth virtual function VF4 may decrease by ‘1’ from ‘6’ to ‘5’.

In at least one example embodiment, the resource manager 1320 may perform the resource allocation operation based on target performance (and/or desired performance, etc.) and/or the number of allocated resources of the virtual function(s). The resource manager 1320 may adjust the number of physical resources allocated to one or more of the plurality of virtual functions VF1 to VF4 based on the target performance and/or the number of allocated resources for each of the plurality of virtual functions VF1 to VF4. The resource manager 1320 may adjust the credits (and/or the number of entries of the command buffer, etc.) of the plurality of virtual functions VF1 to VF4 based on data of the performance difference of the plurality of virtual functions VF1 to VF4. The number of decreased or increased credits may be proportional to target performance of each of the plurality of virtual functions VF1 to VF4 and/or the number of allocated resources to the plurality of virtual functions VF1 to VF4.

For example, when the internal status is changed from the internal operation stop to the internal operation performance, the resource manager 1320 may decrease the credit of each of the plurality of virtual functions VF1 to VF4 based on the internal status for the respective virtual functions. The resource manager 1320 may determine the amount of decreased credits for each of the plurality of virtual functions VF1 to VF4 based on the target performance of each of the plurality of virtual functions VF1 to VF4 and/or the number of allocated resources of each of the plurality of virtual functions VF1 to VF4. Because a previous credit of the first virtual function VF1 is ‘4’, the resource manager 1320 may retrieve (e.g., deallocate, etc.) one entry, and because a previous credit of the second virtual function VF2 is ‘8’, the resource manager 1320 may retrieve (e.g., deallocate, etc.) two entries, etc. That is, a decreased credit (for example, ‘2’) of the second virtual function VF2 may be two times a decreased credit (for example, ‘1’) of the first virtual function VF1.

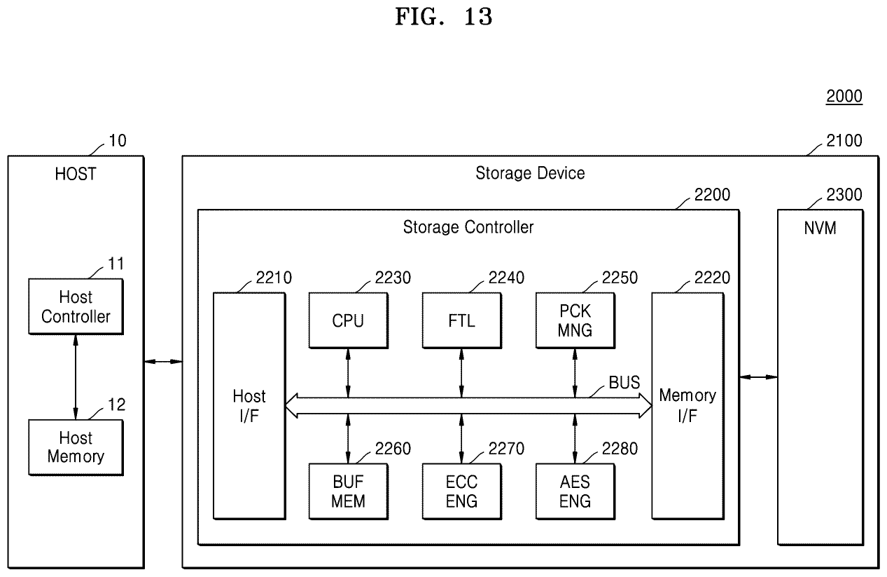

FIG. 13 is a block diagram illustrating a host-storage system 2000 according to at least one example embodiment.

The host-storage system 2000 may include at least one host 10 (e.g., host device) and/or at least one storage device 2100, etc. Also, the storage device 2100 may include at least one storage controller 2200 and/or at least one non-volatile memory (NVM) 2300, etc. Also, according to at least one example embodiment, the host 10 may include at least one host controller 11 and at least one host memory 12. The host memory 12 may function as a buffer memory for temporarily storing data, which is to be transferred to the storage device 2100, and/or data transferred from the storage device 2100, but is not limited thereto.

The storage device 2100 may include non-transitory storage mediums for storing data according to and/or based on at least one request from the host 10. For example, the storage device 2100 may include at least one of an SSD, an embedded memory, and an attachable/detachable external memory, etc., but is not limited thereto. When the storage device 2100 is an SSD, the storage device 2100 may be a device based on NVMe protocol. When the storage device 2100 is an embedded memory and/or an external memory, the storage device 2100 may be a device based on UFS and/or embedded multi-media card (eMMC) protocol, etc. Each of the host 10 and the storage device 2100 may generate at least one packet based on an adopted standard and/or protocol and may transmit the generated packet(s).

When the non-volatile memory 2300 of the storage device 2100 includes flash memory, the flash memory may include a two-dimensional (2D) NAND memory array and/or a three-dimensional (3D) vertical NAND (VNAND) memory array. As another example, the storage device 2100 may include various kinds of non-volatile memories. For example, the storage device 2100 may apply magnetic random access memory (RAM) (MRAM), spin-transfer torque MRAM, conductive bridging RAM (CBRAM), ferroelectric RAM (FeRAM), phase RAM (PRAM), resistive RAM (RRAM), and other various kinds of memories.

According to at least one example embodiment, each of the host controller 11 and the host memory 12 may be implemented as a separate semiconductor chip. Additionally, according to at least one example embodiment, the host controller 11 and the host memory 12 may be integrated into the same semiconductor chip. For example, the host controller 11 may be one of a plurality of modules included in an application processor, and the application processor may be implemented as a system on chip (SoC). Also, the host memory 12 may be an embedded memory included in the application processor, and/or may be a non-volatile memory or a memory module outside and/or external to the application processor.

The host controller 11 may store data (for example, recorded data, etc.) of a buffer area of the host memory 12 in the non-volatile memory 2300 and/or may manage an operation of storing data (for example, read data, etc.) of the non-volatile memory 2300 in the buffer area, but is not limited thereto.

The storage controller 2200 may include a host interface 2210, a memory interface 2220, and/or a central processing unit (CPU) 2230, etc. Also, the storage controller 2200 may further include a flash translation layer (FTL) 2240, a packet manager 2250, a buffer memory 2260, an error correction code (ECC) engine 2270, and/or an advanced encryption standard (AES) engine 2280, but is not limited thereto. The storage controller 2200 may further include a working memory (not shown) into which the FTL 2240 is loaded, and a data write and read operation on the non-volatile memory 2300 may be controlled by executing the FTL 2240 by using the CPU 2230. According to some example embodiments, the storage controller 2200, host interface 2210, memory interface 2220, CPU 2230, FTL 2240, packet manager 2250, buffer memory 2260, ECC engine 2270, AES engine 2280, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The host interface 2210 may transmit and receive a packet to and from the host 10. A packet transmitted from the host 10 to the host interface 2210 may include a command and/or data which is to be recorded in the non-volatile memory 2300, and a packet transmitted from the host interface 2210 to the host 10 may include a response to a command and/or data read from the non-volatile memory 2300. The memory interface 2220 may transmit data, which is to be recorded in the non-volatile memory 2300, to the non-volatile memory 2300, and/or may receive data read from the non-volatile memory 2300. The memory interface 2220 may be implemented to observe a standard, such as Toggle, open NAND flash interface (ONFT), etc.

The FTL 2240 may perform several functions, such as address mapping, wear-leveling, and/or garbage collection, etc. The address mapping operation may be an operation which changes a logical address, received from the host 10, to a physical address which is used to actually store data in the non-volatile memory 2300. The wear-leveling may be technology for allowing blocks of the non-volatile memory 2300 to be uniformly used and thus reducing and/or preventing excessive degradation in a certain block, and for example, may be implemented based on firmware technology which balances the erase counts of physical blocks of the non-volatile memory 2300. The garbage collection may be technology for securing and/or increasing an available capacity in the non-volatile memory 2300 by using a method which copies valid data of a block to a new block and then erases a previous block.

The packet manager 2250 may generate a packet based on a protocol of an interface affiliated with the host 10 and/or may parse various information from the packet received from the host 10. Also, the buffer memory 2260 may temporarily store data which is to be stored in the non-volatile memory 2300 and/or data read from the non-volatile memory 2300. The buffer memory 2260 may be included in the storage controller 2200 and/or may be outside and/or external to the storage controller 2200.

The ECC engine 2270 may perform an error detection and/or correction function on read data read from the non-volatile memory 2300. In more detail, the ECC engine 2270 may generate parity bits of write data which is to be written in the non-volatile memory 2300, and the generated parity bits may be stored in the non-volatile memory 2300 along with the write data. In reading data from the non-volatile memory 2300, the ECC engine 2270 may correct error(s) in the read data by using the parity bits read from the non-volatile memory 2300 and may output error-corrected read data.

The AES engine 2280 may perform at least one of an encryption operation and/or a decryption operation on data input from the storage controller 2200 by using, e.g., a symmetric-key algorithm.

The host 10, as described above with reference to FIGS. 1 to 12B, may include a plurality of virtual machines. The virtual machines included in the host 10 may communicate with corresponding virtual functions of the storage device 2100. The storage device 2100, as described above with reference to FIGS. 1 to 12B, may include a plurality of virtual functions. For example, the host interface 2210 may include a plurality of virtual functions and/or a plurality of sub storage controller. The storage device 2100, as described above with reference to FIGS. 1 to 12B, may include a monitoring operation and a resource allocation operation. The storage device 2100 may dynamically allocate physical sources to the plurality of virtual functions, based on monitored status information.

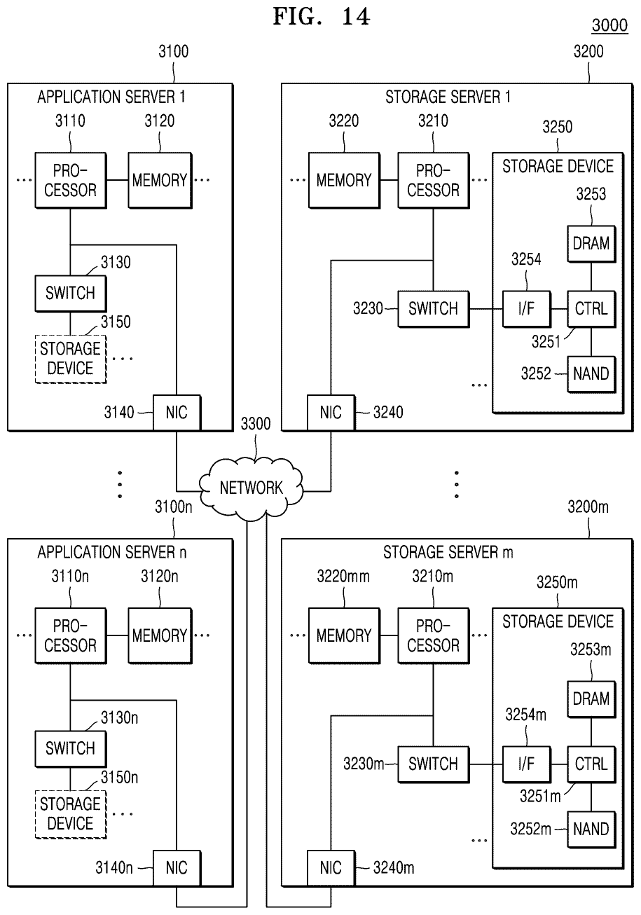

FIG. 14 is a diagram illustrating a data center 3000 to which a storage system according to at least one example embodiment is applied.

Referring to FIG. 14, the data center may be a facility which collects and/or processes various data to provide a service, etc., and may be referred to as a data storage center, data server, cloud server, etc. According to at least one example embodiment, the data center 3000 may be a system for managing and/or operating a search engine and/or a database and may be a computing system which is used by companies, such as banks, etc., and/or government organizations, etc. The data center 3000 may include a plurality of application servers 3100 to 3100n and/or a plurality of storage servers 3200 to 3200m. The number of application servers 3100 to 3100n and/or the number of storage servers 3200 to 3200m may be variously selected according to some example embodiments, and the number of application servers 3100 to 3100n may differ from the number of storage servers 3200 to 3200m.

The application server 3100 and/or the storage server 3200 may include at least one of processors 3110 and 3210 and memories 3120 and 3220. To describe the storage server 3200 for example, the processor 3210 may control the overall operation of the storage server 3200 and may access the memory 3220 to execute an instruction and/or data loaded into the memory 3220. The memory 3220 may be double data rate synchronous DRAM (DDR SDRAM), high bandwidth memory (HBM), hybrid memory cube (HMC), dual in-line memory module (DIMM), optane DIMM, and/or non-volatile DIMM (NVMDIMM), etc., but is not limited thereto. According to at least one example embodiment, the number of processors 3210 and/or the number of memories 3220 each included in the storage server 3200 may be variously selected. In at least one example embodiment, the processor 3210 and the memory 3220 may be provide as a processor-memory pair. In at least one example embodiment, the number of processors 3210 may differ from the number of memories 3220. The processor 3210 may include a single-core processor or a multi-core processor and/or may be a plurality of processors, etc. The description of the storage server 3200 may be similarly applied to the application server 3100. According to at least one example embodiment, the application processor 3100 may omit the storage device 3150. The storage server 3200 may include one or more storage devices 3250. The number of storage devices 3250 included in the storage server 3200 may be variously selected according to at least one example embodiment.

The application servers 3100 to 3100n and/or the storage servers 3200 to 3200m may communicate with each other over at least one network 3300. The network 3300 may be implemented with Fibre channel (FC) and/or Ethernet, but is not limited thereto. In this case, FC may be a medium which is used to transmit data at a relatively high speed and may use an optical switch which provides high performance/high availability. The storage servers 3200 to 3200m may be provided as a file storage, a block storage, and/or an object storage, etc., based on an access scheme of the network 3300.

In at least one example embodiment, the network 3300 may be a storage dedicated network, such as storage area network (SAN). For example, SAN may be FC-SAN which uses an FC network and is implemented based on FC protocol (FCP), etc. As another example, SAN may be IP-SAN which uses a transmission control protocol/Internet protocol (TCP/IP) network and is implemented based on SCSI over TCP/IP or Internet SCSI (iSCSI) protocol. In other some example embodiments, the network 3300 may be a general network, such as TCP/IP network. For example, the network 3300 may be implemented based on protocol, such as FC over Ethernet (FCOE), network attached storage (NAS), and/or NVMe over Fabrics (NVMe-oF), etc.

Hereinafter, the application server 3100 and the storage server 3200 will be mainly described. The description of the application server 3100 may be applied to the other application server 3100n, and the description of the storage server 3200 may be applied to the other storage server 3200m.

The application server 3100 may store data requested by at least one user and/or at least one client to be stored in one of the storage servers 3200 to 3200m over the network 3300. Also, the application server 3100 may obtain data, requested by the user and/or the client to be read, from one of the storage servers 3200 to 3200m over the network 3300. For example, the application server 3100 may be implemented as a web server and/or a database management system (DBMS), but is not limited thereto.

The application server 3100 may access the storage device 3150n and/or the memory 3120n included in the other application server 3100n over the network 3300, or may access the storage devices 3250 to 3250m and/or the memories 3220 to 3220m included in the storage servers 3200 to 3200m over the network 3300. Therefore, the application server 3100 may perform various operations on data stored in the application servers 3100 to 3100n and/or the storage servers 3200 to 3200m. For example, the application server 3100 may execute at least one instruction for moving and/or copying data between the application servers 3100 to 3100n and/or the storage servers 3200 to 3200m, but is not limited thereto. In this case, the data may move from the storage devices 3250 to 3250m of the storage servers 3200 to 3200m to the memories 3120 to 3120n of the application servers 3100 to 3100n directly and/or via the memories 3220 to 3220m of the storage servers 3200 to 3200m. Data moving over the network 3300 may be data encrypted for improved security and/or privacy, etc.

To describe the storage server 3200 for example, the interface 3254 may provide a physical connection between the processor 3210 and a controller 3251 and a physical connection between a network interconnect (NIC) 3240 and the controller 3251. For example, the interface 3254 may be implemented as a direct attached storage (DAS) type which directly accesses the storage device 3250 with a dedicated cable. Also, for example, the interface 3254 may be implemented as various interface types, such as ATASATA, external SATA (e-SATA), small computer system interface (SCSI), SAS, PCI, PCI express (PICe), NVMe, IEEE 1394, universal serial bus (USB), secure digital (SD) card, multimedia card (MMC), embedded multi-media card (eMMC), UFS, embedded UFS (eUFS), and/or compact flash (CF) card interface, etc.

The storage server 3200 may further include at least one switch 3230 and at least one NIC 3240, etc. The switch 3230 may selectively connect the processor 3210 with the storage device 3250 based on control by the processor 3210 and/or may selectively connect the NIC 3240 with the storage device 3250.

In at least one example embodiment, the NIC 3240 may include a network interface card and a network adaptor, but is not limited thereto. The NIC 3240 may be connected with the network 330 by a wired interface, a wireless interface, a Bluetooth interface, and/or an optical interface, etc. The NIC 3240 may include an internal memory, a digital signal processor (DSP), and/or a host bus interface and/or may be connected with the processor 3210 and/or the switch 3230 through the host bus interface. The host bus interface may be implemented as one of examples of the interface 3254 described above. In at least one example embodiment, the NIC 3240 may be provided as one body with at least one of the processor 3210, the switch 3230, and/or the storage device 3250, etc.

In the storage servers 3200 to 3200m and/or the application servers 3100 to 3100n, the processor 3210 may transfer at least one command to the storage devices 3150 to 3150n and 3250 to 3250m and/or the memories 3120 to 3120n and 3220 to 3220m to program and/or read data, etc. In this case, the data may be data where an error has been corrected through an ECC engine, but is not limited thereto. The data may be data obtained through data bus inversion (DBI) and/or data masking (DM) and may include cyclic redundancy code (CRC) information. The data may be data encrypted for improved security and/or privacy.

The storage devices 3150 to 3150n and 3250 to 3250m may transfer at least one control signal and/or at least one command/address signal to NAND flash memory devices 3252 to 3252m in response to at least one read command received from the processor. Therefore, in a case which reads data from the NAND flash memory devices 3252 to 3252m, a read enable (RE) signal may be input as a data output control signal and may allow data to be output to a DQ bus. A data strobe (DQS) may be generated from the RE signal. A command and address signal may be latched in a page buffer based on a rising edge and/or a falling edge of a write enable (WE) signal.

The controller 3251 may overall control at least one operation of the storage device 3250. In at least one example embodiment, the controller 3251 may include static random access memory (SRAM), etc. The controller 3251 may write data in the NAND flash memory device 3252 in response to at least one write command and/or may read data from the NAND flash memory device 3252 in response to at least one read command. For example, the write command and/or the read command may be provided from the processor 3210 of the storage server 3200, the processor 3210m of the other storage server 3200m, and/or the processors 3110 and 3110n of the application servers 3100 and 3100n. The DRAM 3253 may temporarily store (buffer) data which is to be written in the NAND flash memory device 3252 and/or data read from the NAND flash memory device 3252. Also, the DRAM 3253 may store metadata. Here, the metadata may be user data and/or data which is generated by the controller 3251 so as to manage the NAND flash memory device 3252. The storage device 3250 may include a secure element (SE) for improved security and/or privacy.

In at least one example embodiment, the storage devices 3150 to 3150n and 3250 to 3250m may include a plurality of virtual functions. The storage devices 3150 to 3150n and 3250 to 3250m may include the status manager and a resource manager each described above with reference to FIGS. 1 to 12B, but is not limited thereto. The storage devices 3150 to 3150n and 3250 to 3250m may perform the monitoring operation and the resource allocation operation each described above with reference to FIGS. 1 to 12B, but is not limited thereto.

Hereinabove, various example embodiments have been described in the drawings and the specification. The example embodiments have been described by using the terms described herein, but this has been merely used for describing the example embodiments of the inventive concepts and have not been used for limiting a meaning or limiting the scope of the example embodiments of the inventive concepts as defined in the following claims. Therefore, it may be understood by those of ordinary skill in the art that various modifications and other equivalent example embodiments may be implemented from the inventive concepts.

Accordingly, the spirit and scope of the example embodiments of the inventive concepts may be defined based on the spirit and scope of the following claims.

While various example embodiments of the inventive concepts have been particularly shown and described, it will be understood that various changes in form and details may be made therein without departing from the spirit and scope of the following claims.

The invention claimed is:

1. A storage device comprising:
at least one non-volatile memory device; and
processing circuitry configured to control the non-volatile memory device and communicate with at least one external host device through at least one interface channel,
wherein the processing circuitry is further configured to,
monitor performances of a plurality of virtual functions,
generate status information of the plurality of virtual functions based on the monitored performances of the plurality of virtual functions, and
allocate one or more resources to the plurality of virtual functions in real time based on the status information associated with the respective virtual function of the plurality of virtual functions.

2. The storage device of claim 1, wherein the one or more resources comprise at least one of:
a hardware resource, a queue resource, an entry of a command buffer, an interrupt vector, or any combinations thereof.

3. The storage device of claim 1, wherein the processing circuitry is further configured to:
periodically monitor a first current performance of a first virtual function of the plurality of virtual functions.

4. The storage device of claim 3, wherein the processing circuitry is further configured to:
compare the first current performance with a first target performance associated with the first virtual function;
decrease a number of resources allocated to the first virtual function in response to the first current performance being greater than the first target performance; and
increase the number of resources allocated to the first virtual function in response to the first current performance being less than the first target performance.

5. The storage device of claim 3, wherein the processing circuitry is further configured to:
adjust a number of credit associated with one or more of the plurality of virtual functions based on the status information; and
the number of credit represents a number of entries of a command buffer allocated to a respective virtual function of the plurality of virtual functions, the entries of the command buffer configured to store at least one command received from the at least one external host device.

6. The storage device of claim 5, wherein the processing circuitry is further configured to:
compare the first current performance with first target performance of the first virtual function;
decrease the number of credits allocated to the first virtual function in response to the first current performance being greater than the first target performance; and
increase the number of credits allocated to the first virtual function in response to the first current performance being less than the first target performance.

7. The storage device of claim 6, wherein the processing circuitry is further configured to:
adjust the number of credits allocated to the first virtual function in proportion to a difference between the first current performance and the first target performance.

8. An operating method of a storage device, the operating method comprising:
monitoring, using processing circuitry, current performance of a plurality of virtual functions executing on the storage device; and
allocating, using the processing circuitry, one or more resources to one or more of the plurality of virtual functions dynamically based on the monitored current performance of the plurality of virtual functions.

9. The operating method of claim 8, wherein the one or more resources comprise at least one of:
a hardware resource, a queue resource, an entry of a command buffer, an interrupt vector, or any combinations thereof.

10. The operating method of claim 8, wherein the allocating of the one or more resources comprises:
comparing a first current performance of a first virtual function of the plurality of virtual functions with first target performance associated with the first virtual function;
in response to the first current performance being greater than the first target performance, decreasing a number of resources allocated to the first virtual function; and
in response to the first current performance being less than the first target performance, increasing the number of resources allocated to the first virtual function.

11. The operating method of claim 8, wherein the allocating of the one or more resources comprises:
adjusting a number of credits associated with each of the plurality of virtual functions dynamically based on the monitored current performance of the plurality of virtual functions, and
the number of credits corresponds to a number of entries of a command buffer associated with the respective virtual function of the plurality of virtual functions, the command buffer configured to store at least one command received from at least one external host device.

12. The operating method of claim 11, wherein the allocating of the one or more resources comprises:
comparing a first current performance of a first virtual function of the plurality of virtual functions with a first target performance of the first virtual function;
in response to the first current performance being greater than the first target performance, decreasing the number of credits associated with the first virtual function; and
in response to the first current performance being less than the first target performance, increasing the number of credits associated with the first virtual function.

13. The operating method of claim 12, further comprising:
adjusting, using the processing circuitry, the number of credits associated with the first virtual function in proportion to a difference between the first current performance and the first target performance.

14. The operating method of claim 8, further comprising:
receiving, using the processing circuitry, a command to request a deactivation of the resource allocation operation;
deactivating, using the processing circuitry, the monitoring operation in response to the command; and
deactivating, using the processing circuitry, a resource dynamic allocation operation in response to the command.

15. The operating method of claim 8, wherein the monitoring of the performance comprises:
detecting input/output patterns of each of the plurality of virtual functions.

16. The operating method of claim 8, wherein the monitoring of the performance comprises:
monitoring an internal status of the storage device.

17. The operating method of claim 16, wherein the internal status of the storage device represents whether a maintenance and management operation of a non-volatile memory device included in the storage device is being performed.

18. An operating method of a storage device, the operating method comprising:
detecting, using processing circuitry, input/output patterns of a plurality of virtual functions; and
allocating, using the processing circuitry, one or more resources to the plurality of virtual functions dynamically based on the detected input/output patterns of the plurality of virtual functions.

19. The operating method of claim 18, wherein the allocating of the one or more resources comprises:
adjusting a number of credits associated with each of the plurality of virtual functions dynamically based on the detected input/output patterns of the plurality of virtual functions, and
the number of credits associated with each of the plurality of virtual functions corresponding to a number of entries of a command buffer associated with each of the plurality of virtual functions, the command buffer configured to store at least one command received from at least one external host device.

20. The operating method of claim 19, wherein the allocating of the resources comprises:
determining whether a first input/output pattern of a first virtual function of the plurality of virtual functions has changed;
in response to the first input/output pattern of the first virtual function being changed from a sequential input/output pattern to a random input/output pattern, increasing a number of credits associated with the first virtual function;
in response to the first input/output pattern of the first virtual function being changed from a random write input/output pattern to a random read input/output pattern, increasing the number of credits associated with the first virtual function;
in response to the first input/output pattern of the first virtual function being changed from the random input/output pattern to the sequential input/output pattern, decreasing the number of credits associated with the first virtual function; and
in response to the first input/output pattern of the first virtual function being changed from the random read input/output pattern to the random write input/output pattern, decreasing the number of credits associated with the first virtual function.

21.-23. (canceled)
